(19) United States
(12) Patent Application Publication
(10) Pub. No.: US 2021/0398043 A1
(43) Pub. Date: Dec. 23, 2021

(54) SYSTEMS AND METHODS FOR ACCESSING MULTIPLE DATA SOURCES TO DETERMINE LENGTH OF LICENSURE

(71) Applicant: SAMBA Safety Inc., Greenwood Village, CO (US)

(72) Inventor: Richard LACEY, Greenwood Village, CO (US)

(73) Assignee: SAMBA Safety Inc., Greenwood Village, CO (US)

(21) Appl. No.: 17/447,045

(22) Filed: Sep. 7, 2021

Related U.S. Application Data
(63) Continuation-in-part of application No. 17/039,585, filed on Sep. 30, 2020.
(60) Provisional application No. 63/240,197, filed on Sep. 2, 2021.
(60) Provisional application No. 63/074,906, filed on Sep. 4, 2020.
(60) Provisional application No. 62/909,064, filed on Oct. 1, 2019.

(51) Int. Cl. G06Q 10/06; G06Q 10/10

(52) U.S. Cl. CPC G06Q 10/06311; G06Q 10/0635; G06Q 10/1053

(57) ABSTRACT

Systems and method provide access to multiple databases. Information about a person is extracted to determine a length of licensure. If the length of licensure does not cross a predetermined threshold, the system can access a different database. The length of licensure and any indication that the length of licensure crosses the threshold may be returned to a third party.

### CROSS REFERENCE TO RELATED APPLICATIONS

The present application claims priority to, U.S. Provisional Patent Application No. 63/240,197 filed Sep. 2, 2021 entitled “LICENSE HISTORY DISCOVERY,” and U.S. Provisional Patent Application No. 63/074,906, filed Sep. 4, 2020 entitled “Systems and Methods for Determining the Risk of a Driver”. Further, the present application also claims priority to and is a Continuation-in-Part Application of U.S. application Ser. No. 17/039,585 filed Sep. 30, 2020 entitled “Systems and Methods for Providing Automated Driver Evaluation from Multiple Sources,” which claims priority to U.S. Provisional Patent Application No. 62/909,064 filed Oct. 1, 2019 entitled “Systems and Methods for Providing Automated Driver Evaluation from Multiple Sources”. The above applications are incorporated herein by reference in their entirety for all that they teach and for all purposes.

### BRIEF DESCRIPTION OF THE DRAWINGS

FIG. 1 depicts an environment where driver risk may be determined in accordance with examples of the present disclosure.

FIG. 2 depicts an example of a computing environment for conducting the methods described herein in accordance with examples of the present disclosure.

FIG. 3 depicts an example computing system for executing the methods described herein in accordance with examples of the present disclosure.

FIG. 4 depicts another environment where driver risk may be determined in accordance with examples of the present disclosure.

FIG. 5 depicts an example system or software architecture in accordance with examples of the present disclosure.

FIG. 6 depicts another example system or software architecture in accordance with examples of the present disclosure.

FIG. 7 depicts an example data structure that can be sent, received, stored, retrieved, etc. in accordance with examples of the present disclosure.

FIG. 8 depicts another example data structure that can be sent, received, stored, retrieved, etc. in accordance with examples of the present disclosure.

FIG. 9 depicts another example data structure that can be sent, received, stored, retrieved, etc. in accordance with examples of the present disclosure.

FIG. 10 depicts another example data structure that can be sent, received, stored, retrieved, etc. in accordance with examples of the present disclosure.

FIG. 11 depicts an example signaling process in accordance with examples of the present disclosure.

FIG. 12A depicts an example user interface in accordance with examples of the present disclosure.

FIG. 12B depicts another example user interface in accordance with examples of the present disclosure.

FIG. 13 depicts an example method associated with determining driver risk in accordance with examples of the present disclosure.

FIG. 14 depicts another example method associated with determining driver risk in accordance with examples of the present disclosure.

FIG. 15 depicts another example method associated with determining driver risk in accordance with examples of the present disclosure.

FIG. 16 depicts another example method associated with determining driver risk in accordance with examples of the present disclosure.

FIG. 17 depicts another example method associated with determining driver risk in accordance with examples of the present disclosure.

FIG. 18 depicts another example method associated with determining driver risk in accordance with examples of the present disclosure.

FIG. 19 depicts another example method associated with determining driver risk in accordance with examples of the present disclosure.

FIG. 20 depicts another example method associated with determining driver risk in accordance with examples of the present disclosure.

FIG. 21 depicts another example method associated with determining driver risk in accordance with examples of the present disclosure.

FIG. 22 depicts another example method associated with determining driver risk in accordance with examples of the present disclosure.

FIG. 23 depicts another example method associated with determining driver risk in accordance with examples of the present disclosure.

FIG. 24 depicts another example data structure that can be sent, received, stored, retrieved, etc. in accordance with examples of the present disclosure.

FIG. 25 depicts another example data structure that can be sent, received, stored, retrieved, etc. in accordance with examples of the present disclosure.

FIG. 26 depicts another example signaling process in accordance with examples of the present disclosure.

FIG. 27 depicts another example method associated with determining a length of licensure in accordance with examples of the present disclosure.

FIG. 28A-28D depicts another example method associated with determining a length of licensure in accordance with examples of the present disclosure.

### DETAILED DESCRIPTION

Insuring or employing drivers involves risk. Not managing that risk can become costly. Companies can face lawsuits, on-the-job injuries, etc. Thus, companies are always looking to improve both how to determine and manage risk. Many companies rely on predetermined policies that define acceptable risk and avoid employees or drivers that do not meet the predetermined policy requirements. The policies are based on what is perceived to be risky behavior. Unfortunately, these policies are not always accurate or sometime fail to understand the whole environment within the company is operating. As such, some drivers that are not risky may be turned away, while some risky drivers are hired or insured. There is a need for a better system to define and manage risk.

In other situations, employers are looking for multiple drivers to work in the gig economy. Many of the drivers who apply for such jobs are recent relocations to an area and are looking for temporary income. To remain insured, the companies need to verify the licensure of these applicants. Thus, companies attempt to determine the length of licensure of the applicants to ensure it is over some threshold. Unfortunately, for many of these applicants, determining the length of licensure is difficult as they are recently moved to the area. Companies often need to ask for further data from the person. Attempting to obtain information from the previously licenses of the applicant can take many days. These new applicants become frustrated and discontinue the application process. Thus, the companies lose many applicants that could become potential drivers.

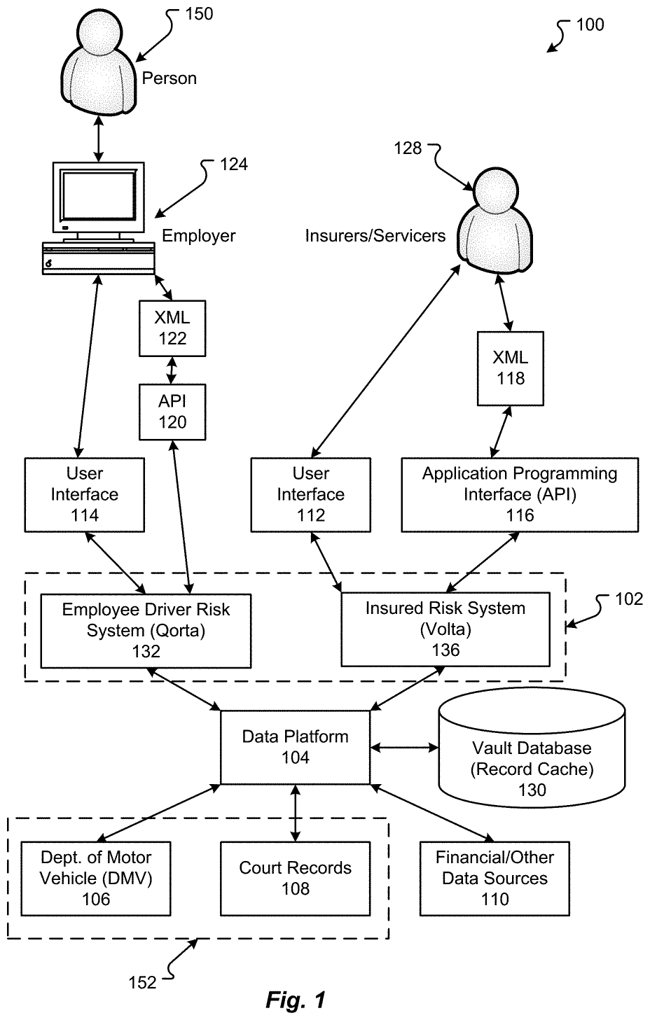

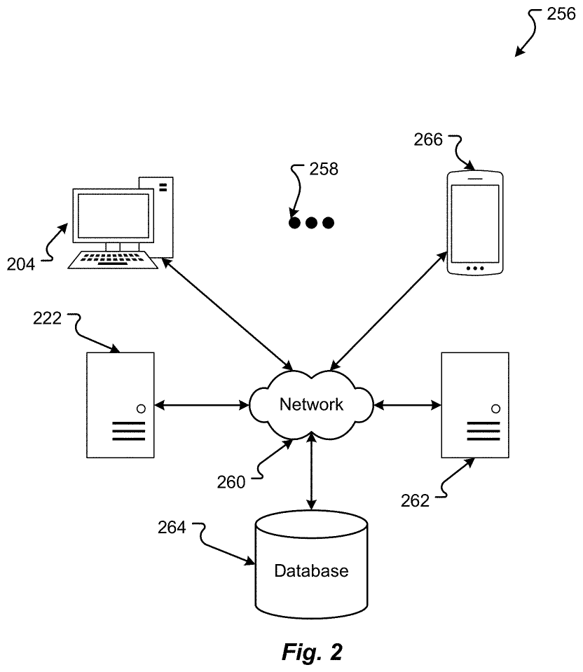

An example of an environment 100 associated with systems for determining a risk that a driver may be involved in a vehicular crash may be as shown in FIG. 1. The systems, components, processes, etc. described in conjunction with FIG. 1 may be as shown hereinafter in FIGS. 2-23. It should be noted that the arrangement and configuration of the components can be different, in some configurations, than that shown in FIG. 1. Further, there may be more or fewer components than that shown in FIG. 1 depending on the configuration desired. Thus, the arrangement shown in FIG. 1 can be physically or logically different than that provided herein, and the description that follows should be construed as an example and not the only possible implementation or configuration possible.

The environment 100 may contain a system 102 for evaluating the risk of a driver crashing. The system 102 can conduct various evaluations for different purposes. One such evaluation may be for insurance risk. A second example evaluation may be for monitoring employees who drive company vehicles. The environment 100 may include one or more systems, e.g., the Employee Driver Risk System 132 (also referred to as the “Qorta” system) and/or the Insured Risk System 136 (also referred to as the “Volta” system), that can be dedicated to the above or other particular evaluation tasks. The system 136 may measure the risk of a crash for an insurance or screener company, or other types of organizations. The system 132 may monitor employees and can evaluate the risk of an employee having an accident. Both systems 132, 136 may be part of the same hardware and software platform system 102, as evidenced by the dotted line. However, in other examples, the systems 132, 136 may be physically separate or logically separate but may use or share at least some data or other systems.

The systems 132, 136 may be in electronic communication with or connected to one or more data platforms 104. The data platform 104 can receive or retrieve data from one or more sources and, if needed, convert that data into a format usable by the systems 132, 136. Thus, the data platform 104 can include one or more interfaces, e.g., application programming interfaces (APIs), that can each receive data from a data source and convert that data into a common or usable format. For example, the data platform 104 may have a first API (e.g., a state database interface) that may be in communication with a Department of Motor Vehicle (DMV) datastore 106 associated with one or more States, Provinces, Regions, etc. The DMV datastore 106 may provide Motor Vehicle Records (MVRs) or other information about a driver that drives in that State, Province, etc.

Further, the data platform 104 can also be in communication, through a state database interface, with or connected to the records department of one or more courts 108 of one or more States, Provinces, Regions, etc. The court information may include any type of arrest records or adjudications or convictions for motor vehicle violations or other unlawful activity. The DMV datastore 106 and/or the court records 108 may be referred to as state databases 152. The state databases 152 can also include other data sources besides the DMV datastore 106 and court records 108. The state databases 152 include any source of data about a person 150 that may be stored and provided by a department or entity associated with a State, Province, County, etc.

The data platform 104 can include any APIs to connect to and retrieve data from one or more other data sources 110, which can include, for example, telematics data from one or more vehicles driven by the driver, insurance company information, foreign car registrations or driving records, or other types of clerk data, employer data, etc. Another source 110 that may be interfaced with, by a data platform 104, is a financial entity database. The financial entity database 110 can be information from a credit reporting agency, a bank, or other type of financial entity. People can apply for financial instruments, for example, a credit application or loan, and use their driver's license for identity purposes. This driver's license information may be stored by the financial entity 110.

The system 132 may also provide data to a user interface (UI) 114, which may create a UI display that may be sent or provided to employers 124. The UI 114 can include one or more items of hardware or software to produce and display the data in a UI. The display data can be sent from the UI 114 to a display device associated with the third party system 124. Employers may also send requests or other types of inputs to the system 132 through means other than a user interface. One such request a third party system 124 may send, is a request to determine the length of licensure of a person. The person 150 may be interfacing with the third party system 124 through an application executed at the third party system 124. The application may allow the person 150 to apply for a driving position where the person's length of licensure must be determined. The information about the person 150 may be forwarded from the third party system 124 to the system 132. This information may include data from the person's current driver's license or other types of biographic data.

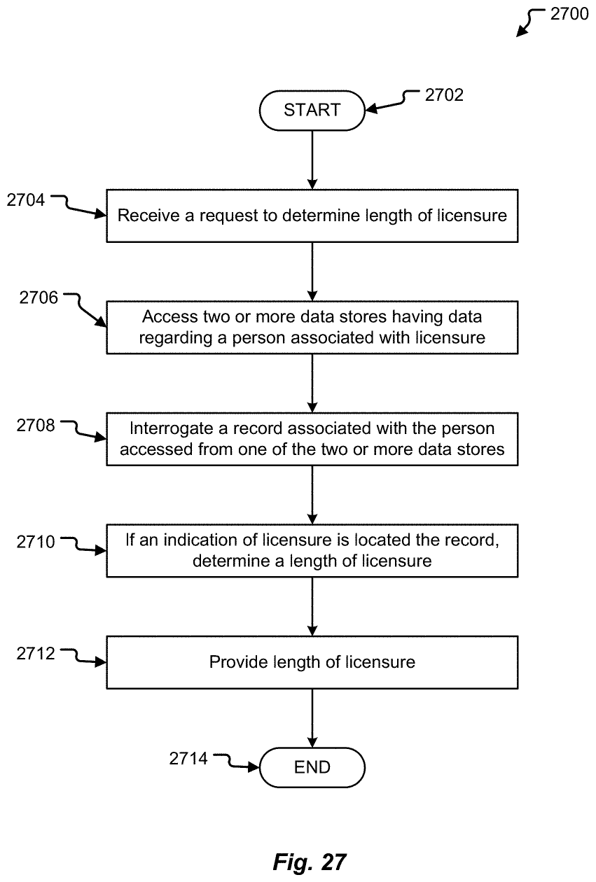

In some instances, the system 132 can provide data to the third party system 124 in other forms. For example, the system 132 can send data to an API 120 to provide a document 122 (e.g., an XML document) or other types of outputs to employers for use in analysis by those employers 124. The UI 114 or the API 120 can provide information about the risk of one or more employees having an accident now or in the future. Thus, the UI 114 or document 122 may be updated periodically, for example, every day, every hour, once a week, etc. The system 132 can provide data back to the employer 124 about the length of licensure of a person 150. The return from the system 132 back to the third party system 124, may be a determination of the earliest date of an event that indicates the person had a license. An example of the return to the third party system 124 may be data structure 2400 shown in FIG. 24 describes hereinafter.

The system 136 may also send data to a UI 112 to provide information through to insurers 128 and/or other companies, agencies, governmental functions, etc. The System 136 may also use an API 116 to provide a document or other output 118 to insurers 128 for their use in the analysis of data. Both the UI 112 and the API 116 may function similarly to UI 114 and API 120 but deliver data to a different party. The UI 112 and the API 116 can provide information about a risk of driver having an accident for insurance assessment.

FIG. 2 represents a hardware/software configuration for the environment 100. A server 222 can be any computing system as described in conjunction with FIG. 1, e.g., the system 102, the data platform 104, etc. The computing environment 256 that may function as the servers, user computers, or other systems provided and described herein, in accordance with implementations of the present disclosure. The computing environment 256 includes one or more user computers, or computing devices, such as a computing device 204, a communication device 266, and/or other devices, as represented by ellipses 258. The devices 204, 266, etc. may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems.

These devices 204, 266, etc. may also have any of a variety of applications, including for example, database client and/or server applications, and web browser applications. Alternatively, the devices 204, 266, etc. may be any other electronic device, such as a thin-client computer, Internet-enabled mobile telephone, and/or personal digital assistant, capable of communicating via a network 260 and/or displaying and navigating web pages or other types of electronic documents. Although the exemplary computing environment 256 is shown with two computing devices, any number of user computers or computing devices may be supported.

The computing environment 256 may also include one or more servers 222, 262. In this example, server 262 is shown as a web server and server 222 is shown as an application server. The web server 262, which may be used to process requests, for web pages or other electronic documents, from devices 204, 266, etc. The web server 262 can be running an operating system including any of those discussed above, as well as any commercially-available server operating systems. The web server 262 can also run a variety of server applications, including SIP (Session Initiation Protocol) servers, HTTP(s) servers, FTP servers, CGI servers, database servers, Java servers, and the like. In some instances, the web server 262 may publish operations available operations as one or more web services.

The computing environment 256 may also include one or more file and/or application servers 222, which can, in addition to an operating system, include one or more applications accessible by a client running on one or more of the devices 204, 266, etc. In at least some configurations, the application server 222 can provide model data, e.g., risk scores, to devices 204, 266, etc.

The server(s) 222 and/or 262 may be one or more general purpose computers capable of executing programs or scripts in response to the devices 204, 266, etc. As one example, the server 222, 262 may execute one or more web applications. The web application may be implemented as one or more scripts or programs written in any programming language, such as Java™, C, C#®, or C++, and/or any scripting language, such as Perl, Python, or TCL, as well as combinations of any programming/scripting languages. The application server(s) 222 may also include database servers, including without limitation those commercially available from Oracle®, Microsoft®, Sybase®, IBM® and the like, which can process requests from database clients running on a device 204, 262, etc.

The web pages created by the server 262 and/or 222 may be forwarded to a device 204, 262, etc. via a web (file) server 262, 222. Similarly, the web server 262 may be able to receive web page requests, web services invocations, and/or input data from a device 204, 262, etc. (e.g., a user computer, etc.) and can forward the web page requests and/or input data to the web (application) server 222.

In further implementations, the server 222 may function as a file server. Although for ease of description, FIG. 2 illustrates a separate web server 262 and file/application server 222, those skilled in the art will recognize that the functions described with respect to servers 262, 222 may be performed by a single server and/or a plurality of specialized servers, depending on implementation-specific needs and parameters. The computer systems 204, 262, etc., web (file) server 262 and/or web (application) server 222 may function as the system, devices, or components described herein.

The computing environment 256 may also include a database 264. The database 264 may reside in a variety of locations. By way of example, database 264 may reside on a storage medium local to (and/or resident in) one or more of the computers 204, 262, 262, 222, etc. Alternatively, database 264 may be remote from any or all the computers 204, 262, 262, 222, etc., and in communication (e.g., via the network 260) with one or more of these. And in still other implementations, the database 264 can have portions of the database local and remote to any or all the computers 204, 262, 262, 222, etc.

The database 264 may reside in a storage-area network (“SAN”) familiar to those skilled in the art. Similarly, any necessary files for performing the functions attributed to the computers 204, 262, etc., 266, 222 may be stored locally on the respective computer and/or remotely, as appropriate. The database 264 may be a relational database, such as Oracle 20i®, that is adapted to store, update, and retrieve data in response to SQL-formatted commands. Database 264 may represent databases and/or datastores 106, 108, 130, and/or 110. In implementations, the vault database 130 may be a record cache and may be alternatively referred to as a record cache 130. The record cache 130 can cache old MVRs or other types of data about a person 150 that may be local to the data platform 104. The record cache 130 can store and make available old records associated with the person 150 that may not need to be ordered and paid for again from a state database 152.

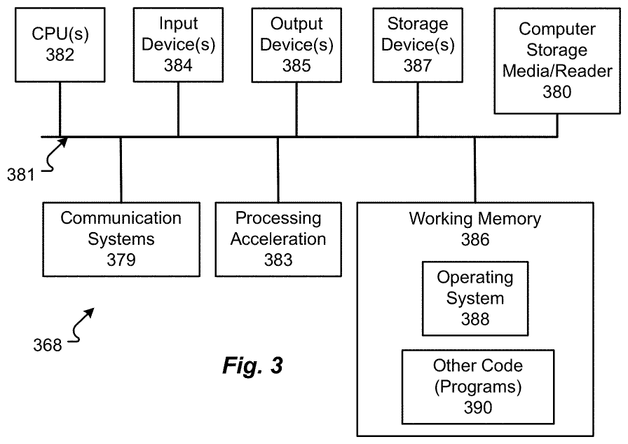

FIG. 3 illustrates one implementation of a computer system 368 upon which the servers 222, 262, user computers 204-266, computing devices, or other systems or components described above may be deployed or executed. The computer system 368 is shown comprising hardware elements that may be electrically coupled via a bus 381. The hardware elements may include one or more central processing units (CPUs) 382; one or more input devices 384 (e.g., a mouse, a keyboard, etc.); and one or more output devices 385 (e.g., a display device, a printer, etc.). The computer system 368 may also include one or more storage devices 387. By way of example, storage device(s) 387 may be disk drives, optical storage devices, solid-state storage devices such as a random access memory (“RAM”) and/or a read-only memory (“ROM”), which can be programmable, flash-updateable and/or the like.

The computer system 368 may additionally include a computer-readable storage media/reader 380; a communications system 379 (e.g., a modem, a network card (wireless or wired), an infra-red communication device, etc.); and working memory 386, which may include RAM and ROM devices as described above. The computer system 368 may also include a processing acceleration unit 383, which can include a digital signal processor (DSP), a special-purpose processor, and/or the like.

The computer-readable storage media/reader 380 can further be connected to a computer-readable storage medium, together (and, optionally, in combination with storage device(s) 387) comprehensively representing remote, local, fixed, and/or removable storage devices plus storage media for temporarily and/or more permanently containing computer-readable information. The communications system 379 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 368 may also comprise software elements, shown as being currently located within a working memory 386, including an operating system 388 and/or other code 390. It should be appreciated that alternate implementations of a computer system 368 may have numerous variations from that described above. For example, customized hardware might also be used and/or elements might be implemented in hardware, software (including portable software, such as applets), or both. Further, connection to other computing devices such as network input/output devices may be employed.

Examples of the processors 382 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM936EJ-S™ processors, other industry-equivalent processors, and may perform computational functions using any known or future-developed standard, instruction set, libraries, and/or architecture.

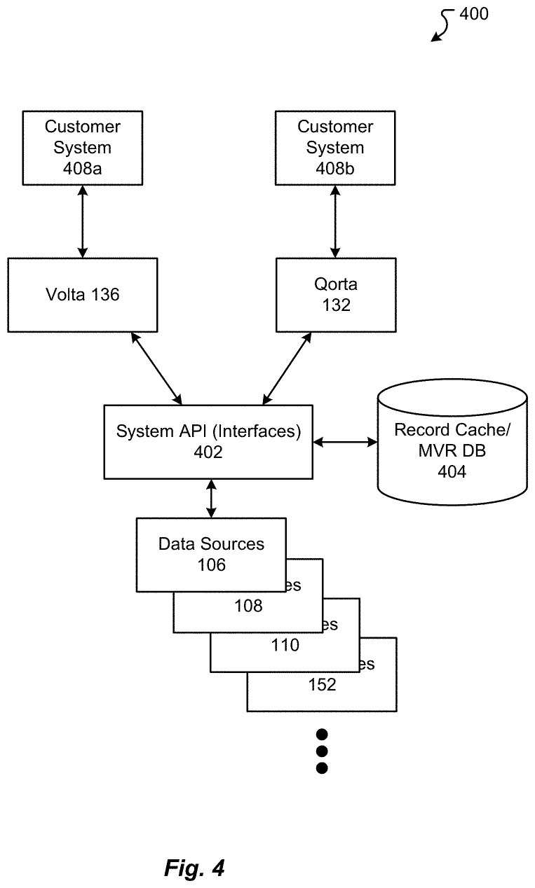

An implementation of another environment 400 that may include at least some portion of environment 100 may be as shown in FIG. 4. The customer system 408a, 408b (e.g., the third party system 124 or insurer 128) may be in communication with the System 136 or the system 132. Both the System 136 and the system 132 may be in communication with one or more interfaces 402, e.g. an API, that can access either the DMV datastore 106 or an MVR datastore (DB) 404 or other data stores, databases, or data sources. The interfaces 402, which may be referred to herein as API 402, can intercept calls to the DMV datastore 106 from either the System 136 or the system 132. The API 402 can determine if the MVR was already retrieved and then stored in the MVR DB 404 (the MVR DB 404 may be a portion of the vault database 130). Thus, if information from System 132 is retrieved and saved in the MVR DB 404, that stored information may be later retrieved from the MVR DB 404 by the System 136 and vice versa. In this way, the systems 132, 136 can share information, which makes the retrieval of this information less time consuming and may use fewer resources.

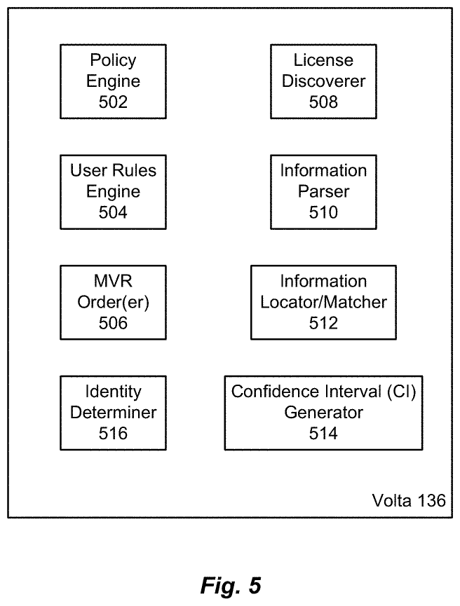

An implementation of software system associated with the System 136 may be as shown in FIG. 5. The different components described in conjunction FIG. 5 may be described herein as software, however, those components can also be hardware devices for example gates constructed in a field programmable gate array (FPGA), an application specific integrated circuit (ASIC), or other device.

The System 136 can include one or more of, but is not limited to, a policy engine 502, a user rules engine 504, an MVR Orderer 506, a license discover 508, an information parser 510, an information locator/matcher 512, a confidence interval (CI) generator 514, and/or an identity determiner 516. The policy engine 502 can receive user input or conduct other processes to create or evaluate a policy. A policy is a set of rules created to determine if a driver should be insured. For example, one rule can be that no person with more than three speeding tickets in the past year will be insured. The policy can include one or more of these types of rules. The policy engine 502 can analyze information against the policy to determine whether the rules are met or violated. Policy engine 502 may also store any policy for the one or more customers and retrieve the policy as needed.

The user rules engine 504 can receive rules from the client or customer of the System 136. The rules can consist of how data or other items of information should be reviewed. These user rules may be stored with the policy or separate from the policy depending upon the circumstances. The rules may then be retrieved and compared against information as required by the user rules engine 504.

An MVR orderer 506 may be operable to determine when an MVR should be ordered and then order that MVR from an MVR data system of a State. MVR Orderer 506 can analyze user rules, provided by the user rules engine 504, for determining when an MVR should be ordered. Further, MVR Orderer 506 can also provide information to a client when an MVR is not to be ordered based on user rules or other information. MVR Orderer 506 can send any request or signal, required by the various States, to the various States' APIs to order the MVR or receive that MVR. MVR Orderer 506 may then translate or transform the MVR data as necessary to put the data into a format or condition that may be evaluated by the System 136.

The license discover 508 can determine if a license is available for a driver who is providing information but id denying that they have a license. The person may suggest that they do not have a license but provides some type of biographical information. License discover 508 can search for that biographical information or similar information in one or more MVR records or other data. By parsing and then discovering information, the license discover 508 can determine if a license may have been issued for the individual in some state.

The information parser 510 may be operable to parse information provided by one or more insurance applicants. The information parser 510 can also extract information from MVR records or other data. This parsing of information may then transform or translate the parsed data into a standard form or format for use by other types of components described herein. Thus, while each State or country may have a unique format for MVR data, the information parser 510 can use one or more APIs to translate the data into a common format for use by the System 136 and the components described herein.

An information locator/matcher 512 can locate information within different MVR's or other different data sources. The information to be located may determine an identity of a driver, a license of the driver, or some other type of information. The location or matching of information may then be reported to one or more components for determination of identity, license, etc.

The CI generator 514 can determine the strength of a correlation between known data and a determination made by a component, as described herein. For example, the license discover 508 can match licenses to the biographical information, which can cause the CI generator 514 to generate a CI. The CI generator 514 may use one or more different rules or algorithms to generate the CI. Other components may request or require a CI from the CI generator 514, including, but not limited to, the identity determiner 516 and the policy engine 502.

The identity determiner 516 may, like the license discover 508, use information provided from a driver to determine the actual identity of the person. The person may give information that may be biographical, which may then be matched to information in MVRs or to data from other sources. Based on any matches in the information, the identity determiner 516 can then determine whether the person matches the identity that the person provided or has a different identity, e.g., is using an alias or a fake identity. This determined identity may then be used to determine insurability.

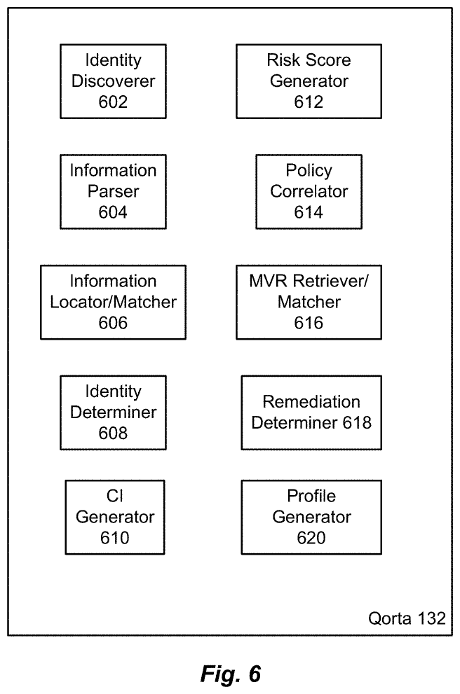

An implementation of another software system, for the system 132, may be as shown in FIG. 6. The system 132 can include one or more of, but is not limited to, an identity discoverer 602, an information parser 604, an information locator/matcher 606, an identity determiner 608, a CI generator 610, a risk score generator 612, a policy correlator 614, a MVR retriever/matcher 616, a remediation determiner 618, and a profile generator 620. The identity discoverer 602, information parser 604, information locator/matcher 606, identity determiner 608, and the confidence interval generator 610 may be the same as the components with similar names as described in conjunction FIG. 5. As such, these components will not be explained further herein but the above description applies to these components.

The risk score generator 612 can determine a risk or for an individual employee driver being monitored. This risk score may correlate to the likelihood of that the driver may have an accident within a next period of time (e.g., the next 6 months, the next year, etc.). The risk score generator 612 can deploy an artificial intelligence engine that can generate a model that determines risk scores based on information about the individual. The model can create a profile of the driver, which may include past data ingested by the artificial intelligence engine to determine risk score.

The policy correlator 614 may match or analyze the generated risk score, provided by the risk score generator 612, to or against a policy provided by the employer. The policy may be a set of rules that indicates whether the driver or employee should be hired or used for certain functions. The policy correlator 614 can analyze whether the policy correlates to or has similar results to the risk score. For example, if the policy is approving drivers with high risk scores or the policy is denying drivers with low risk scores. Differences between the risk score and the result arrived by the policy may be determined and then determine if the policy is inaccurate and/or ineffective. This analysis information may be provided, by System 132, to the user for adjustment of the policy.

The MVR retriever/matcher 616 may match MVR records and/or retrieve MVR records based on either the risk score generated or the policy correlator information. The MVRs associated with certain drivers, which are not or should not be hired based on their risk score, will not be ordered. Similarly, individuals that have very low risk scores need not have an MVR ordered based on their small likelihood that those individuals will have an accident. Thus, the MVR retriever/matcher 616 can determine when to order the MVR.

Remediation determiner 618 can determine when an employee requires training or other types of remediation to adjust or address changes in their risk score. The remediation determiner 618 may monitor real-time generated risk scores as those risk scores are being adjusted by the risk score generator 612. If the risk score drops below some predetermined threshold, the remediation determiner 618 can determine that the individual requires remediation. Further, depending on the characteristics of the change in the risk score, for example, the rate of change of the risk score, the remediation determiner 618 may determine which type of remediation to provide to the individual.

The profile generator 620 can generate a profile for an individual. The profile may be one or more different items of information that characterize the individual driver and the risk that driver poses. Thus, the profile generator 620 may document and provide the characteristics underlying the risk score generator's 612 determination of the risk score.

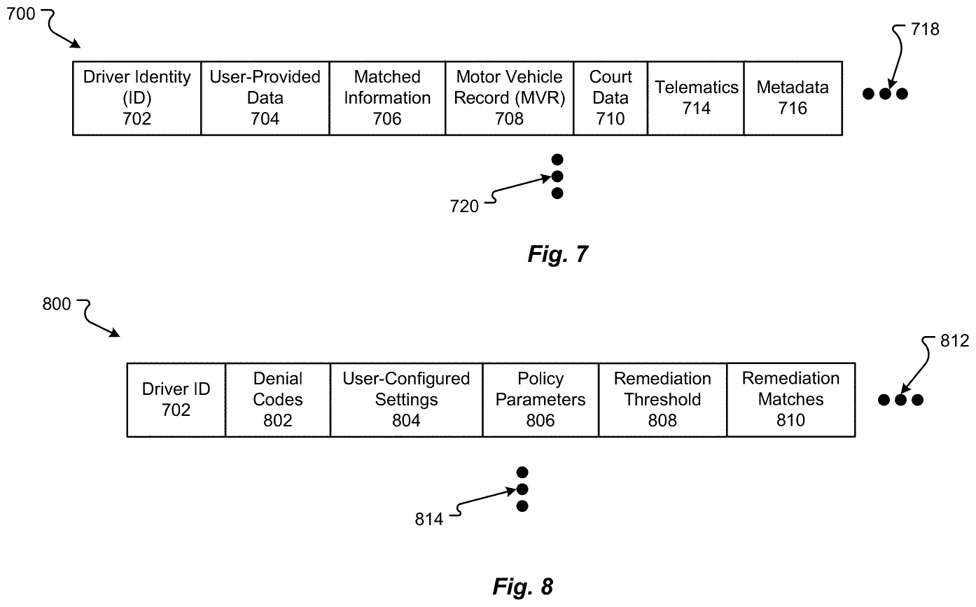

An implementation of the inbound data structure 700 that may include inbound data may be as shown in FIG. 7. Inbound data 700 can include any data provided or retrieved from or by a data source, as described in conjunction with FIG. 1. Inbound data 700 can also represent any data received by a driver or user. The inbound data 700 can include one or more of, but is not limited to, a driver identifier (ID) 702, user provided data 704, matched information 706, MVR information 708, court information 710, telematics information 714, and/or metadata 716. There may be more or fewer fields, in the inbound data, as represented by the ellipses 718. Each driver or employee may have a different set of inbound data associated therewith, and thus, there may be more data structures 700 than those shown in FIG. 7, as represented by ellipses 720.

The driver ID 702 can be any type of identification of the driver. This driver information can include, for example, the driver's name, the driver's address, the driver's Social Security number, the driver's license number, a uniquely created identifier (for example, an alphanumeric identifier, a globally unique identifier (GUID), etc.), vehicle identification, or other types of identifiers. This driver's ID 702 uniquely identifies this driver amongst other drivers within the system. The driver identifier 702 can also be two or more different items of information that may be used in conjunction to determine the identity of the driver.

User provided data 704 can include any type of data provided by the user that may be used to determine the identity or license of the driver. This user provided data 704 can include, for example, a name, an alias, an address, an event, an event associated with a time, or other types of information. The provided data 704 is data that is provided by the user and stored.

Matched information 706 can be any information that is matched, based on the user provided data 704, to other information. The matched information 706 can include the identity of a driver, the name of the driver, or other types of information that are determined based off of other information. The matched information 706 may be extracted from one or more data sources, as described in conjunction with FIG. 1.

The MVR information 708 can include any information that is provided from a motor vehicle record. MVR information 708 can include, for example, information about driving offenses (e.g., speeding tickets), information about accidents or other types driving infractions, information about tickets issued, or other types of information, which may be recorded by one or more States or other governmental entities, involving a user's motor vehicle record. This MVR information 708 may be stored by the vehicle departments of various governments. As such, the user may have two or more motor vehicle records from two or more government entities. This MVR information may be consolidated into the MVR information 708. Therefore, the MVR information 708 may be associated with the governmental entity that provided the data, a date, a location, or other information or metadata.

Court information 710 can be any information provided by court records from the courts of various States or governments. Court information 710 can include, for example, information about convictions for motor vehicle offenses, convictions for other types of offenses, charges that were dropped or pleaded out in various States or governments, and/or other court-related information. The court information 710 may come from two or more states, as such, the court information 710 may also be associated with times and locations of where the user may have been living. Court information 710 may be consolidated into the court information 710 from the various States or governments.

Telematics information 714 can be one or more items of information recorded from real-time driving (e.g., if the driver has installed a device on the driver's automobile or is executing an application on the driver's mobile phone or other type of device to record different events while driving). These events can include hard stops, speeding, or other types of information about the driver's driving characteristics. Telematics information 714 may be uploaded on a periodic basis, and thus, can be updated with dates and locations over the course of time. Telematics information 714 may be real-time and thus can change the inbound data 700 based on user's current driving.

The metadata 716 can include any other information about the information provided in the inbound data 700. This metadata 716 can include information, for example, a rate of change, a date, a location, changes to locations where things occurred, or other types of information. Metadata 716 allows for the analysis of how recent a change occurred, a tight grouping of events in location or time, where a change(s) occurred, etc.

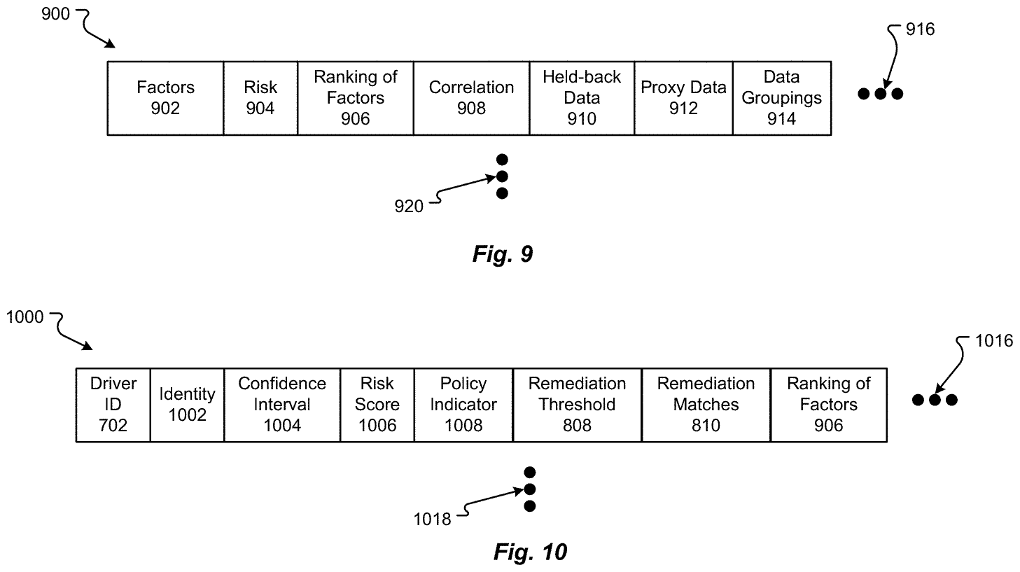

An implementation of the policy data structure 800 representing policy data as may be provided by one or more insurers and/or employers may be as shown in FIG. 8. There may be more or fewer fields than that shown in FIG. 8, as represented by ellipses 812. Each policy for each employer or insurer may be different and thus, there may be more data structures 800 than those shown in FIG. 8, as represented by ellipses 814. The policy data 800 can include one or more of, but is not limited to, the driver ID 702, denial codes 802, user-configured settings 804, policy parameters 806, a remediation threshold(s) 808, and/or remediation matches 810. The driver ID 702 may be the same or similar to the driver ID 702 as described in conjunction with FIG. 7, as such, the driver ID 702 will not be described further herein.

Denial codes 802 can include the different codes used by the policy to deny a driver either insurance or employment. Denial codes 802 can include a collection of one or more incidents that if that incident occurred (sometimes within a predetermined period of time in the past), the driver will be denied insurance or employment. For example, denial codes 802 can include two or more speeding tickets within six months, and two or more accidents within three years, or other types of events or combinations of events. These denial codes 802 may be universal and provided by the system or may be generated and provided by the employees or insurers.

User-configured settings 804 can include any type of extra information or analysis that an employer or insurer may desire conducted on the data. These user-configured settings 804 may be provided through a user interface or other type of input to the policy data 800. User-configured settings 804 can allow the insurer or employer to customize how data can be stored or analyzed.

Policy parameters 806 can include any type of parameters placed within the policy. These policy parameters 806 can include, for example, user-defined parameters or other types of settings. The policy parameters 806 can include what type of drivers will be eliminated or should be monitored or trained. This information 806 can include sets of the thresholds, for when events should occur, based on the current information, with either insured drivers or employees, and what type of action should be conducted during those events.

The remediation threshold 808 can include the threshold compared to the risk score at which the employee should be provided remediation. For example, for a risk score 904 that falls below a certain level, the driver may be required to take training. This threshold 808 may be user set or may be provided automatically by the system.

Remediation matches 810 may be the remediation that should be provided to the driver, based on the driver's profile and the employee's policy data. The remediation could be training or other types of events. Remediation matches 810 indicate at what different risk score levels and what driver characteristics indicate which drivers are to receive remediation and the type of remediation to be given.

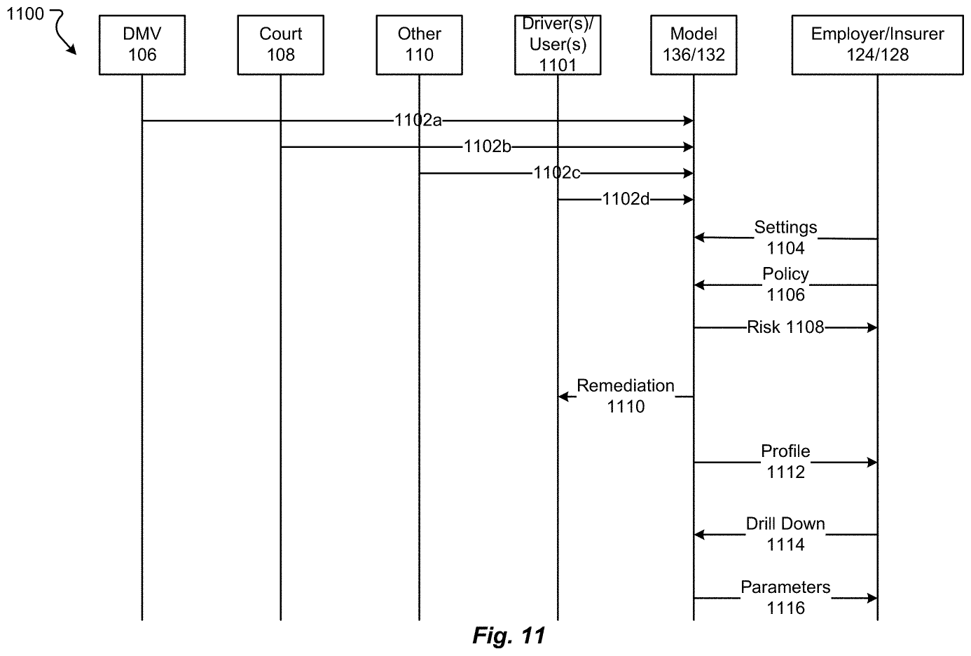

An example of model data 900 may be as shown in FIG. 9. The model data 900 can include any of the different types of model information used to create the model that provides the risk score or other types of analysis within the system. Further, model data 900 can include information generated from the model based on driver information. There may be more or fewer data's fields in the model data 900, within FIG. 9, as indicated by ellipses 916. Further, each model, which may be associated with different employers or insurers, may have a different set of model data 900 based on what industry or how the information is analyzed, which is represented by ellipses 916. Model data 900 can include one or more of, but is not limited to, a driver ID 702, factors 902, risk or risk score 904, a ranking of factors 906, a correlation 908, held back data 910, proxy data 920, and/or data groupings 914. The driver ID 702 may be the same or similar to driver ID 702 described in conjunction with FIG. 7, and therefore, will not be discussed more here.

The factors 902 can include any type of data, analytics and/or characteristics that can be used to model the risk of a driver. These factors 902 can include, for example, how long the person's had their driver's license or commercial driver's license (CDL), the state(s) with which the CDL driver's license was issued, the age of the person, the number of speeding tickets that have occurred, the timing of any events, any accidents that may have happened, any charges against the driver for unlawful activity, any convictions for unlawful activity, the State where the person is living, the number of months, days, years, etc. of employment of the person, whether the person is being evaluated, the type of training the person has had, etc. These various factors 902 can include either singular or a plurality factors that are combined into new factors. Any of the factors 902 may be used to determine a risk score.

A risk score 904 may be a risk generated by the model. The risk 904 can be determined by algorithms that use the factors 902. The risk score 904 can include a score based on a predetermined scale. For example, the risk score 904 can be a score from 0 to 100 were 100 is a safe driver and zero is a risky driver. The risk score 904 can also be created by two or more algorithms that may be evaluated in sequence to determine the risk. These algorithms can include a weight of factors model or other types of modeling used to determine the risk.

The ranking of factors 906 can include any type of ranking or assigned importance of the factors 902. These rankings of factors 906 can include a weight, by percentage, of the score or value assigned to the factor. Other weights can be used. The ranking of factors 906 can also list or order the factors 902, from the factor that most influences the risk score 904 to the factor that has the least effect on the risk score 904. The ranking of factors 906 can also eliminate some portion of factors based on the rank compared to a threshold. Thus, factors 902 that have little effect on the risk score 904 need not be evaluated.

Correlation 908 is an amount of correlation between the factor 902 and the risk score 904. The correlation 908 can be the determination of how important the factors 902 are in determining the risk of the driver. Correlation 908 may also be an input to the ranking of factors 906. Correlation may be indicated by a place in a list, a tier, or some other type of organization.

Held-back data 910 includes any data that may be reserved to check the model for effectiveness or accuracy. The held-back data 910 can include some portion of data collected in the original generation of the model to verify that the model is accurate. Held-back data 910 can include, for example, 20% of the data or some other percentage of the data set used to generation the model. Held-back data 910 may be indicated by some symbol that indicates that the data is not used in original generation of the model but is used in verification.

Proxy data 912 indicates any type of data that may need to be input manually or automatically because that data may be missing from the data set. For example, a set of data, regarding a driver, may be partial and include only some data used by the model. Proxy data 912 can place default or some other type of generated data into that data set as proxy data 912. Proxy data 912 allows the model to evaluate all data together, rather than encounter problems in generating a model based on missing data.

Data groupings 914 include any type of groupings of the factors 902. Some data does not necessarily need to be evaluated individually. Rather, data that exhibits like outcomes may be grouped together, where the model analyzes the group rather than the members of the group. Data groupings 914 can include two or more items the data that may be included in a set and then analyzed by the set, rather than the individual data. Data groupings 914 can be based on temporal considerations, physical considerations, geographic considerations, etc. For example, data groupings 914 can be a set of five states that have similar outcomes or are within geographic proximity. Other data groupings can include, for example, a set of miles per hour that indicate speeding. For example, from 5 to 10 miles over the speed limit may be one group, while a second group can be 10 to 20 mph, etc. These types of groupings allow the model to evaluate a driver more efficiently as the data set is smaller.

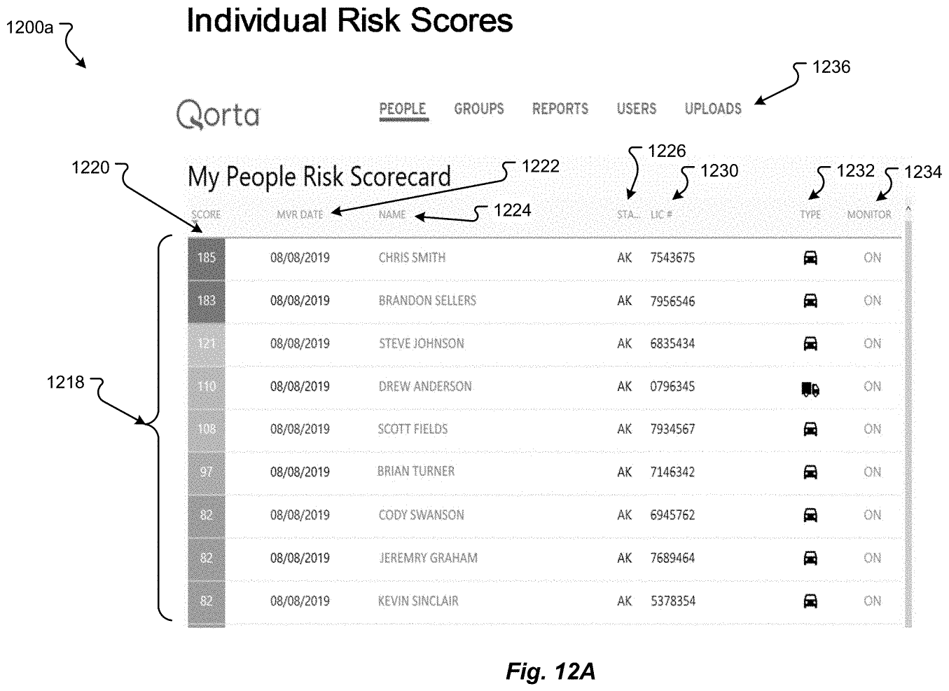

A data structure 1000 associated with profile data of a driver and output by a model may be as shown in FIG. 10. There may be more or fewer fields than that provided in data structure 1000, as represented by ellipses 1016. Further, each employer or insurer may have their own profile data associated with a driver, and thus, there may be more data structures 700 than those shown in FIG. 10, as represented by ellipses 1018. The profile data structure 1000 can include one or more of, but is not limited to, a driver ID 702, an identity 1002, a CI 1004, a risk score 1006, a policy indicator 1008, a remediation threshold 808, remediation matches 810, and/or a ranking of factors 906. The driver ID 702 may be the same or similar to the driver ID 02 as described in conjunction with FIG. 7, as such, the driver ID 702 will not be explained further here. The remediation threshold 808, remediation matches 810, and the ranking of factors 906 may be the same or similar to the remediation threshold 808, remediation matches 810, and the ranking of factors 906 as described in conjunction with FIGS. 8 and 9, as such, the remediation threshold 808, remediation matches 810, and the ranking of factors 906 will not be explained further here.

The identity 1002 can be the identity determined by the system and stored here. The identity 1002 can include any biographical data, for example, name, age, address, or other data. The identity 1002 may also be provided by the driver.

The identity 1002 may be associated with a confidence interval 1004. The confidence interval 1004 indicates a confidence interval for the identity 1002 provided or determined. Further, the confidence interval 1004 can also include another confidence interval associated with the risk score 1006 or other data within the data structure 1000. The CI 1004 for the risk score 1006 can include an indication of the confidence of how the risky the employee is to drive.

The risk score 1006 can include the score generated by the system and describes the risk associated with the user. This risk score 1006 can be based off of multifactor analysis produced by the model of the artificial intelligence engine. The risk score 1006 can also be used by the system to determine remediation or other events that may occur when associated with the employee.

The policy indicator 1008 is an indicator of what policy data structure 800 may be associated with the employee. This policy indicator 1008 can be a reference or a link to the policy data 800. Thus, the policy indicator 1008 associates the profile data 1000 with the policy 800.

Ranking of factors 906 can indicate which factors are most important for generating the risk score 1006 associated with this employee. Ranking of factors 906 can be provided to an employer to indicate why the risk score 1006 was provided to this user.

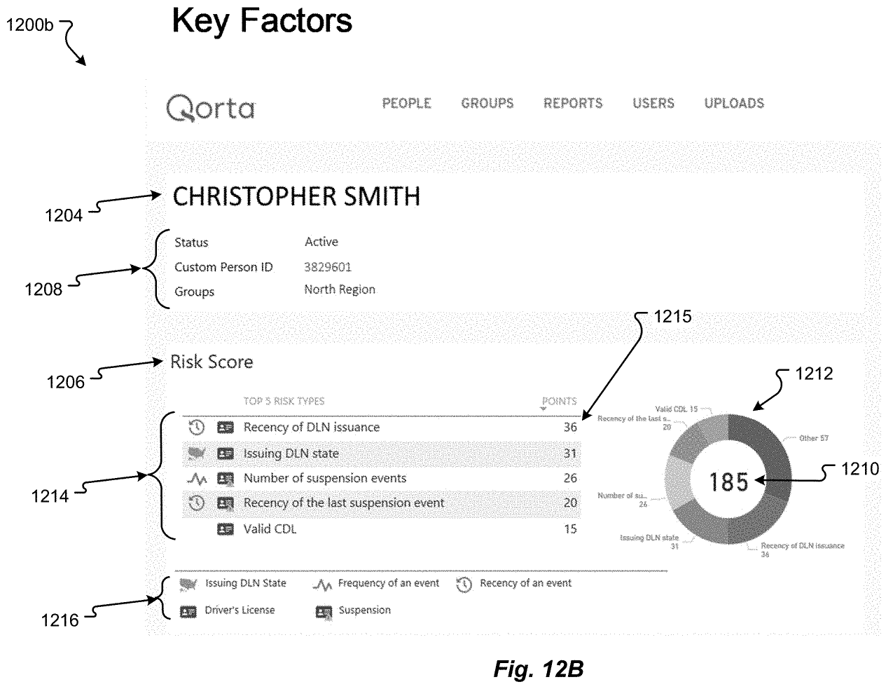

An example of a signaling diagram or process 1100 may be as shown in FIG. 11. Here, the diagram 1100 shows signals being sent between the DMV datastore 106 of at least one State, the court 108 of at least one State, other data sources 110, a driver/user 1101, a model 136/132, and an employer or insurer or underwriter 124/128.

In first signals 1102a, 1102b, 1102c, and 1102d, data may be collected for the model. Signal 1002a sends data from the DMV datastore 106 to the model 136/132. Signal 1102b sends data from the court 108 to the model 132/136, while the other data sources 110 send data in signal 1102c. The user sends data to the model 132/136 in signal 1102d. The data sent may be inbound data 700 or other data as described herein.

The model 132/136 may also receive settings or other information from the employer and/or the insurer 124/128, in signal 1104. Further, the employer may also send the policy data, in signal 1106. The model 900 may then use some or all of the received data to generate and/or apply a model that analyzes the risk of the driver 1101. The output from this analysis may be a risk score or a risk analysis or assessment, which may be sent, in signal 1108, back to the employer or insurer 124/128.

Should the policy 1106 deem that the risk score, in signal 1108, requires remediation, the indication for remediation and what that reason remediation shall be may be sent, by the model 900, to the driver 1101, in signal 1110. Further, based on the risk score, in signal 1108, the third party system 124/128 may desire to review the profile to understand why that risk score was provided. This profile may be sent in signal 1112 to the third party system 124/128. The third party system 124/128 may send a signal 1114 to drill down into the profile to determine what part of the profile was important in the generation the risk score. The model 132/136 can receive this drill down signal 1114, and in response, the model 132/136 can send one or more parameters back to the employer, in signal 1116, for the employer to review.

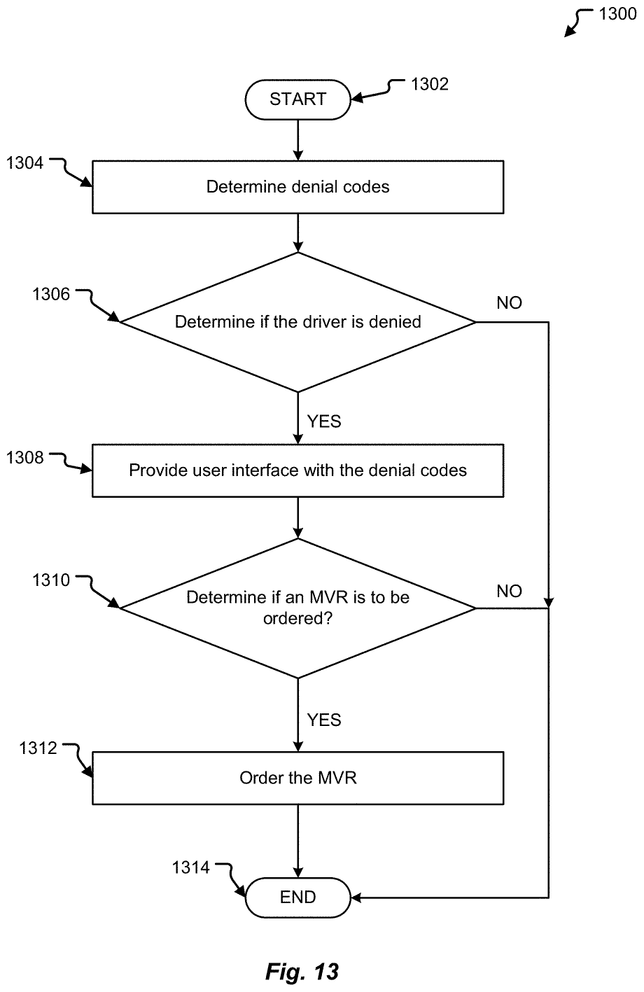

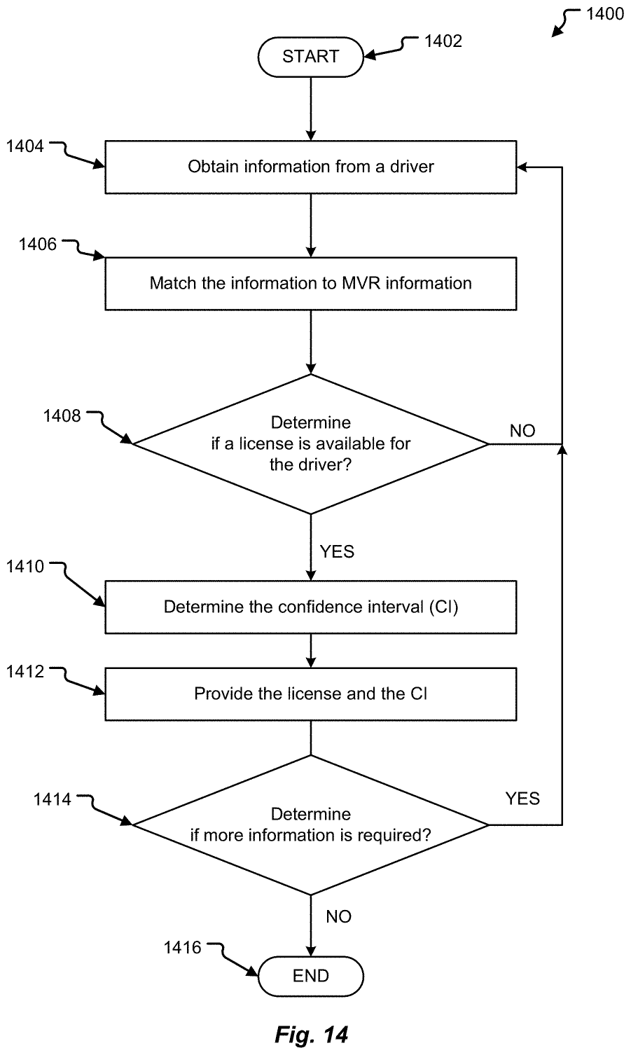

An implementation of the user interface 1200a that provides a list of driver profiles and risk scores for one or more drivers may be as shown in FIG. 12A. The user interface 1200a may include a list 1218 of two or more drivers having risk scores associated therewith. The risk score for each driver may be provided in column 1220. As shown in user interface 1200a, the list of drivers 1218 may be ordered based on the value of the risk score in column 1220. In the example shown in FIG. 1200a, the riskiest driver is listed at the top of the list while the least risky driver is listed at the bottom of the list. The column of risk scores 1220 may also include a visual indicia to indicate the level of risk for each driver. For example, the riskiest drivers may have a red box surrounding the risk score. The least risky drivers may have a green box surrounding the risk score. Other data may be provided within the list 1218.

In column 1222, the date of the latest motor vehicle record retrieved and associated with the driver may be shown. In column 1224, the name of the driver in the list 1218 may be shown. Further, the State in which the driver resides or operates may be provided in column 1226. The license number for the driver may be provided in column 1230. The type of license owned by the driver may be provided in column 1232. Here, a visual indicia may indicate whether the driver has a CDL or just a standard motor vehicle license (e.g., the picture of the truck indicates the driver has a CDL). Finally, in column 1234, an indication of whether the driver is being monitored as an employee may be indicated. The column 1234 can include a binary indication of whether the driver is being monitored. For example, column 1234 can include the word “On” if the driver is being monitored.

Some or all the different items in the columns 1220 through 1234 may be selectable by user. Selectable elements may be indicated by a change or difference in visual indicia. For example, a user may select the name, in column 1224, to receive information associated with that particular driver. The ability to select the name may be indicated by visual indicia, for example, the difference in color, in this case, the names being listed as blue rather than black. The monitoring status, in column 1234, may also be selectable as indicated by the monitoring status being shown in green rather than black. By selecting the monitoring status, the user may change the monitoring status for the individual.

The user interface portion 1208 can also include other types of information. Different windows may be provided when one or more of the words in the list 1236 are selected. However, by selecting the word “People,” in the list 1236, the list 1218 may be provided. Thus, the user interface portion 1208 can be provided by user interaction. When the user selects a name from column 1224, the user interface 1200b, as shown in FIG. 12B, may be provided.

An example of a user interface 1200b that provides a risk score for one individual may be as shown in FIG. 12B. These interfaces 1200 may be provided in response to a selection of user interface device in a previously provided user interface. For example, a list of names with risk scores may be provided to the user, as shown in FIG. 12A. When the user selects one of the names, either by interacting with the username or the risk score associated with that user data, user interface 1200b may be provided in response.

The user interface 1200b may include one or more sections or portions, each displaying different information that may be user selectable or may be interacted with by the user. These portions can include, an employee or an insured's name 1204, as displayed at the top the user interface 1200b. Further, biographical information about the driver may be provided in portion 1208, which can include, for example, the status of the person, the person's supervisor, the person's group or employer, etc. Another portion 1206 may include risk score information. The risk score information in portion 1206 can include the risk score 1210, displayed as a number 1210 and a visual indicia 1212, of the breakout of different factors that may be affecting the risk score. The visual indicia 1212 of the factors may be also listed, as a list, in portion 1214, including the percentage of points assigned 1215 and how those factors affect the risk score. Further information about remediation or other items or a key or other information may be provided in portion 1216.

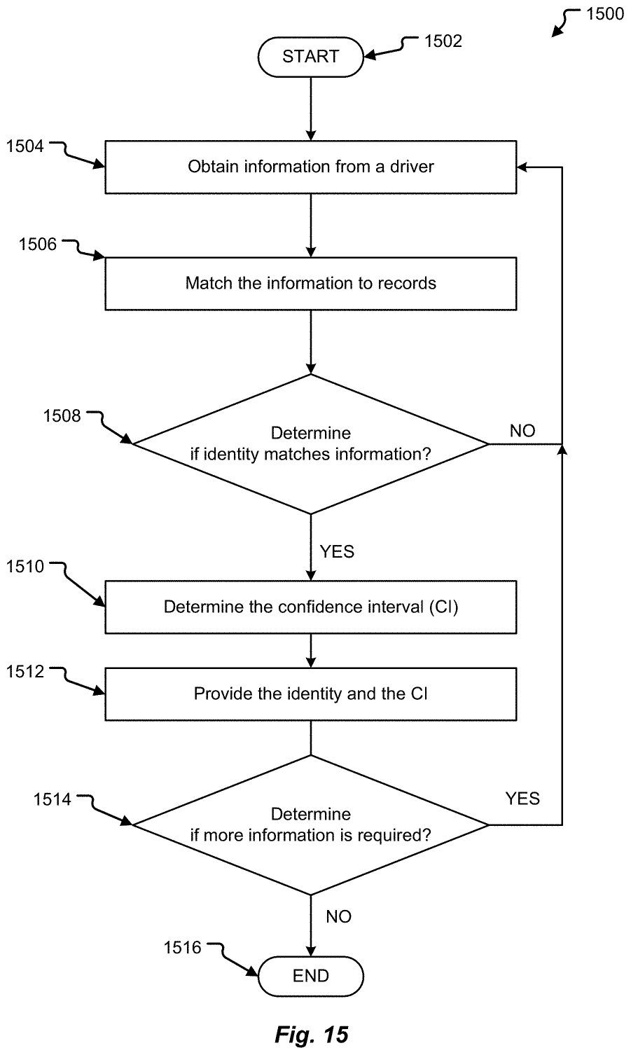

An implementation of a method 1300 for determining whether to order a motor vehicle record may be as shown in FIG. 13 in accordance with examples of the present disclosure. A general order for the operations or stages of the method 1300 is shown in FIG. 13. Generally, the method 1300 starts with a start operation 1302 and ends with an end operation 1314. The method 1300 can include more or fewer operations or stages or can arrange the order of the operations or stages differently than those shown in FIG. 13. The method 1300 can be executed as a set of computer-executable instructions executed by a processor, such as processor 382 of the system 132 or the System 136, and encoded or stored on a computer readable medium. Further, the method 1300 can be performed by gates or circuits associated with a processor, an ASIC, a FPGA, a SOC, or other hardware device. Hereinafter, the method 1300 shall be explained with reference to the systems, components, devices, modules, software, signals, data structures, user interfaces, methods, etc. described in conjunction with FIGS. 1-12B and 14-23; however, it will be understood by those of skill in the art that some or all of the operations of method 1300 can be performed by or using different elements from those described below.

The policy engine 502, of the System 136, can determine denial codes, in stage 1304. The policy engine 502 can access the policy data, in data structure 800. The denial codes 802 can be retrieved by the policy engine 502 and used to determine whether a driver is denied coverage or employment based on past events.

The policy engine 502 receives information about the driver from the information parser or information locator/matcher 512. That information is scanned to determine if it matches denial codes 802, in stage 1306. If an event matches one or more denial codes, the method 1300 proceeds “YES” to stage 1308. If no event matches a denial code and the driver can be insured or employed, the method 1300 proceeds “NO” to end stage 1314.

In stage 1308, the policy engine 502 can provide the denial code information to a user interface for the insurer or employer. In this way, the policy engine 502 can provide reasons for why a driver was denied coverage or employment by the denial codes. Producing the denial codes is unique in that the reason for denial was not known in the past. In this way, the policy engine 502 can provide the ability for an intervention by a user or some other person and to determine whether the person denied automatically by the policy should be allowed to receive coverage or employment.

The user may also want an MVR depending on the denial code. Thus, the MVR Orderer 506 can determine if an MVR is to be ordered, in stage 1310. In some situations, the type of denial code is so severe, e.g., multiple crashes in six months, convictions for drag racing, etc., that the person would be denied regardless of what is provided in the MVR. In these situations, the MVR Orderer 506 may forgo the ordering of an MVR. In other situations, e.g., there are no denial codes, there are only minor denial codes, the driver's risk score is so low, etc. the MVR Orderer 506 may also forgo ordering an MVR because there are no or minor issues with the driver. Thus, the type of denial code may be part of a predetermined group of denial codes that do not required ordering an MVR. A user may establish which denial codes form the group.

In other instances, the denial codes are placed in the group automatically based on the association of the denial code with the likelihood a driver will have an accident in the near future. In other circumstances, the driver's risk score crosses a threshold that can trigger the ordering or forgo the ordering of an MVR. These thresholds may be predetermined by a user or may be automatically set based on the likelihood the risk is indicative (there is a statistical correlation) that the driver will have an accident in the near future.

When there is no definitive determination of the risk based on the denial code, then the MVR Orderer 506 may order the MVR by sending a request to one or more MVR sources (e.g., the DMV datastore 106), in stage 1312.

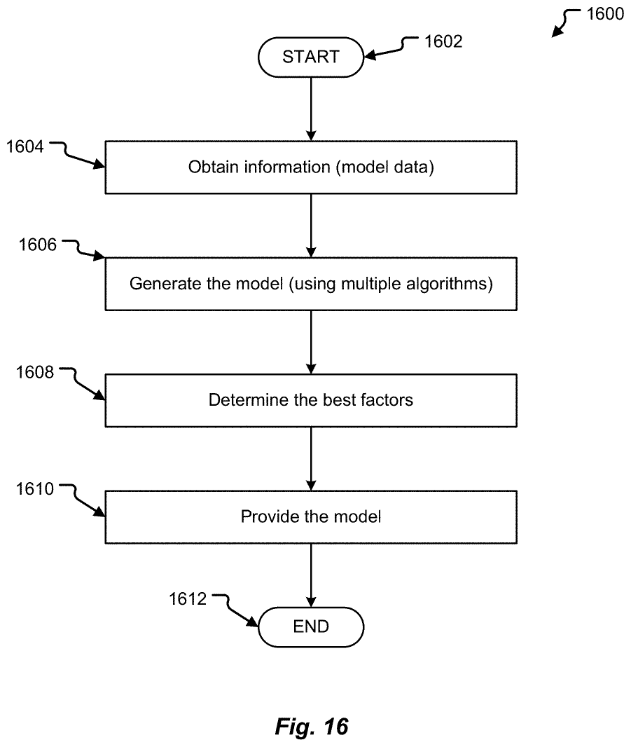

An implementation of a method 1400 for determining whether a license is available for driver may be as shown in FIG. 14, in accordance with examples of the present disclosure. A general order for the operations or stages of the method 1400 is shown in FIG. 14. Generally, the method 1400 starts with a start operation 1402 and ends with an end operation 1416. The method 1400 can include more or fewer operations or stages or can arrange the order of the operations or stages differently than those shown in FIG. 14. The method 1400 can be executed as a set of computer-executable instructions executed by a processor, such as processor 382 of the system 132 or the System 136, and encoded or stored on a computer readable medium. Further, the method 1400 can be performed by gates or circuits associated with a processor, an ASIC, a FPGA, a SOC, or other hardware device. Hereinafter, the method 1400 shall be explained with reference to the systems, components, devices, modules, software, signals, data structures, user interfaces, methods, etc. described in conjunction with FIGS. 1-13 and 15-23; however, it will be understood by those of skill in the art that some or all of the operations of method 1400 can be performed by or using different elements from those described below.

The information parser 510 can receive or obtain information from the driver, for example, user provided data 704, in stage 1404. The information may be some or all information associated with the driver. This information may be accurate or not accurate, depending on the truthfulness of the driver.

The information parser 510 can extract the data provided and provide the extracted data to the information locator/matcher 512. Then, the information locator/matcher 512 can try to match the provided information to information in MVRs from one or more States, in stage 1406. In one configuration, the information locator/matcher 512 can access information in the vault database 130. In this way, the system 136 need not access the DMV datastores 106 before first attempting to locate the information in previously stored data. Regardless, the information locator/matcher 512 can determine what type of matches there are for any of the biographical or other data. For example, the information locator/matcher 512 can try and match addresses and times to match names or aliases of people who lived at those addresses. In another example, the information locator/matcher 512 can match Social Security numbers or other types of data.

After analyzing the data, the information locator/matcher 512 can provide that information to the license discover 508. The license discover 508 then determines if a license is available, in stage 1408. If the information provided matches some information in an MVR, and there is a license associated with that driver, then the license discover 508 determines a license is available. If the license is available, the method 1400 proceeds “YES” to stage 1410. However, if the license is determined not to be available, the method proceeds “NO” back to stage 1404. The information used to make the match is then provided to the CI generator 514.

In stage 1410, the CI generator 514 determines the confidence interval. Here, the CI generator 514 determines how likely the match of the information and license(s) is accurate. This analysis can be both based on information provided by the driver and the information found, but also be based pm other information that may be discovered on the license or associated with the license. For example, a photograph of the person on the license may be compared to a photograph of the driver, which may have been provided by the driver or taken of the driver. If the photograph matches the driver, then there is a high confidence that the license is associated with that driver. Further, the confidence interval determined, in stage 1410, can also be affected by the number of different data characteristics matching and some level of correlation based on what types of characteristics are matched.

The license discover 508 can provide both the license discovered and the confidence interval to the user, in stage 1412. The provision of the license and CI can be in a user interface sent to the third party system 124 or insurer 128. The user interface can include one or more items the data in the license to show the user whether the person may have a license.

The user may request more information, in stage 1414. This more information may include other licenses that may have been found or other types of data. Further, the user may elicit more information from the driver to determine if licenses are still available, in stage 1414. This more information can be requested based off a suggestion from the license discover 508 about whether a license was discovered or not. If more information is needed, the method 1400 proceeds “YES” to stage 1404. If no more information is needed, the method 1400 proceeds “NO” to end stage 1416.

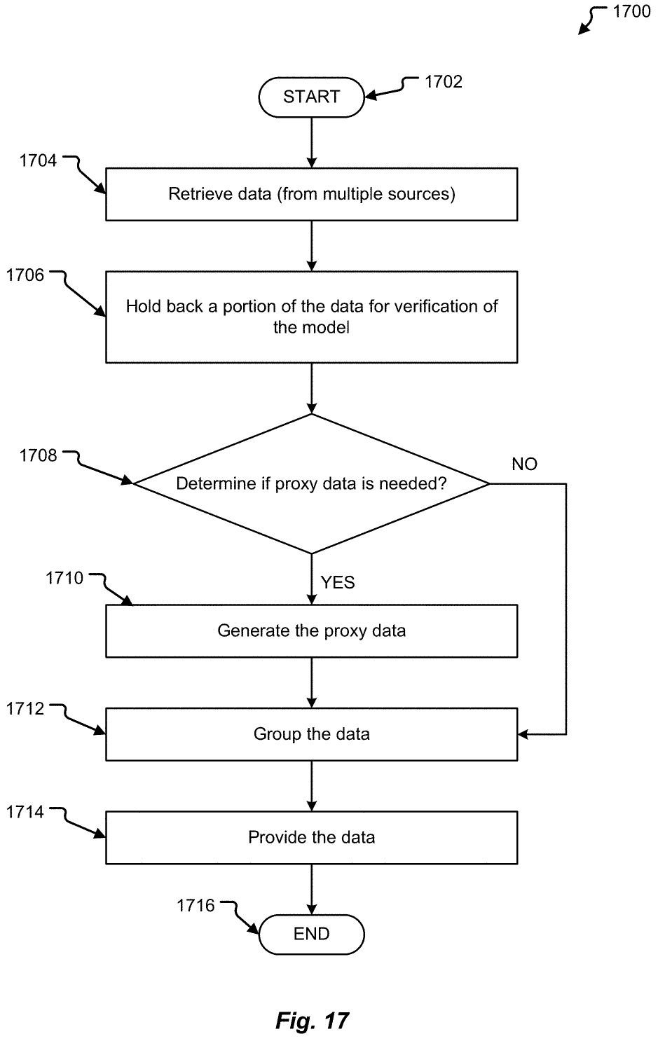

An example of a method 1500 for determining the identity of a driver may be as shown in FIG. 15, in accordance with examples of the present disclosure. A general order for the operations or stages of the method 1500 is shown in FIG. 15. Generally, the method 1500 starts with a start operation 1502 and ends with an end operation 1516. The method 1500 can include more or fewer operations or stages or can arrange the order of the operations or stages differently than those shown in FIG. 15. The method 1500 can be executed as a set of computer-executable instructions executed by a processor, such as processor 382 of the system 132 or the System 136, and encoded or stored on a computer readable medium. Further, the method 1500 can be performed by gates or circuits associated with a processor, an ASIC, a FPGA, a SOC, or other hardware device. Hereinafter, the method 1500 shall be explained with reference to the systems, components, devices, modules, software, signals, data structures, user interfaces, methods, etc. described in conjunction with FIGS. 1-14 and 16-23; however, it will be understood by those of skill in the art that some or all of the operations of method 1500 can be performed by or using different elements from those described below.

The information parser 510 can receive or obtain information from the driver, in stage 1504. The driver may provide information through a user interface or provide information to another person that can input into the System 136. That information may then be stored as inbound data 700 in the user provided data field 704. The information may then be provided to the identity determiner 516.

The identity determiner 516 may then request that the information parser 510 and the information locator/matcher 512 parse the information and then match the information to data within one or more MVRs or other data sources, for example, the DMV datastore 106, the courts 108, or other sources 110, in stage 1506. Thus, the information locator/matcher 512 can crawl through the data sources to determine if the information provided is located and matches some identity. As explained with the license discovery, the information may be match by location, by time, or by other factors. The correlations between the data and the information given by the driver may be provided back to the identity determiner 516.

The identity determiner 516 can then determine if an identity matches the data, in stage 1508. If the identity is matched, the method 1500 proceeds “YES” to stage 1510. If the identity does not match the data given or an identity is not found, the method proceeds “NO” to return to stage 1504, where more information may be gathered from the driver. In stage 1510, the identity determiner 516 can provide the information to the CI generator 514. The CI generator 514 may then determine the confidence interval that describes the likelihood that the identity discovered is a match, in stage 1510. The confidence interval may be determined similar to what was explained with the license discovery method in FIG. 14. The confidence interval can determine how much the identity matches the information provided. Thus, the CI gives an indication as to the strength of the match.

The identity determiner 516 may then provide the identity and the CI, in stage 1512. The identity determiner 516 can provide a user interface with the identity and provide that to the user. The identity may include pictures or other information for the user to confirm the identity discovered.

At that point, the user may request for more information, in stage 1514. Thus, the user can override the decision or the determination made by the identity determiner 516 and request more information from the driver. If more information is required, the method 1500 proceeds “YES” back to stage 1504. However, if the user is satisfied with the determination of the identity and does not require more information, the method 1500 may proceed “NO” to end stage 1516.

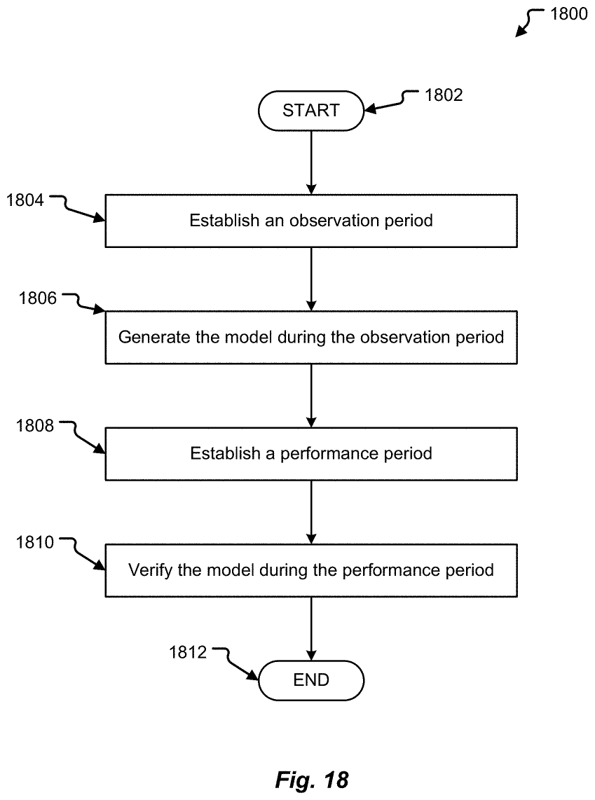

An example of a method 1600 for generating a model to determine risk for drivers may be as shown in FIG. 16, in accordance with examples of the present disclosure. The method 1600 can determine a model based on one or more factors using one or more algorithms in the model. A general order for the operations or stages of the method 1600 is shown in FIG. 16. Generally, the method 1600 starts with a start operation 1602 and ends with an end operation 1612. The method 1600 can include more or fewer operations or stages or can arrange the order of the operations or stages differently than those shown in FIG. 16. The method 1600 can be executed as a set of computer-executable instructions executed by a processor, such as processor 382 of the system 132 or the System 136, and encoded or stored on a computer readable medium. Further, the method 1600 can be performed by gates or circuits associated with a processor, an ASIC, a FPGA, a SOC, or other hardware device. Hereinafter, the method 1600 shall be explained with reference to the systems, components, devices, modules, software, signals, data structures, user interfaces, methods, etc. described in conjunction with FIGS. 1-15 and 17-23; however, it will be understood by those of skill in the art that some or all of the operations of method 1600 can be performed by or using different elements from those described below.

In a first stage, the risk score generator 612 or some other component of the System 136 can obtain information about a plurality of drivers, in stage 1604. The information may be provided to an information parser 604. This data can include the data provided from inbound data 700 or other seed data. This driver information may be fed to the risk score generator 612 to generate a model, in stage 1606. The risk score generator 612 can function as the model generator and use one or more algorithms, for example, a weighted average or some other type of model using existing algorithms or newly created algorithms, to produce a model. The model may be based off past data that can then evaluate future data to determine the risk of a driver.

The risk can be the risk that the driver will have an accident within the next six months, year, or some other period of time. The model may be generated use multiple algorithms. This generated model can include a set of factors 902. The risk score generator 612 can determine the best factors, in stage 1608. The best factors can be listed in a ranking of factors 906. The best factors indicate which factors most influence risk for driver. This information along with any correlation between the factors and risk may be provided in data structure 900.

This model and factor information may then be provided, by the risk score generator 612, in stage 1610. The model can be provided to the user for future use. In some configurations, the model may be generated and then reviewed for some period of time. This two-stage process can ensure that the model generates effective risk score calculations.

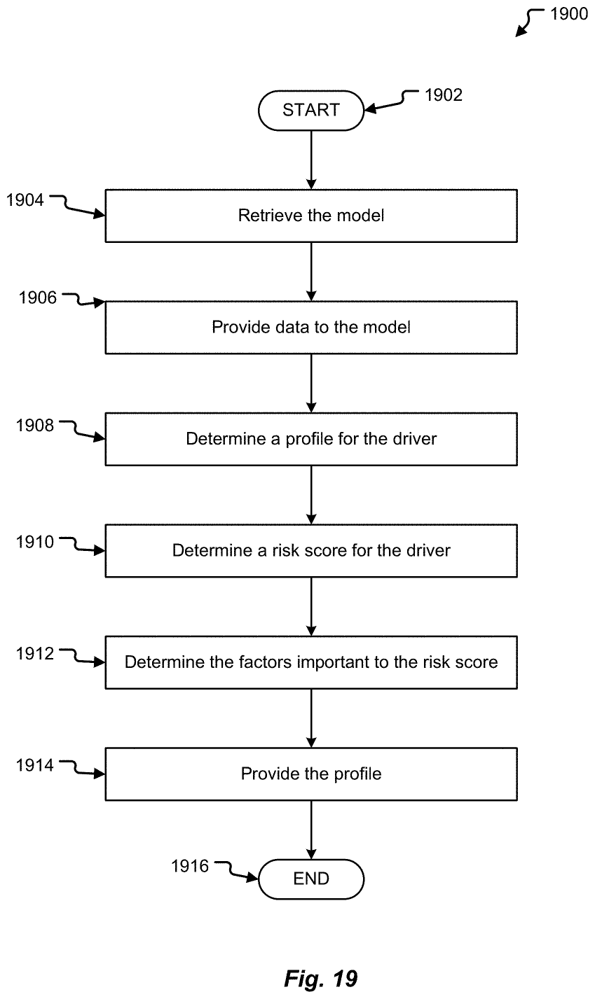

An example of a method 1700 for obtaining information or data about a driver, which may expand on stage 1604 in FIG. 16, may be as shown in FIG. 17, in accordance with examples of the present disclosure. A general order for the operations or stages of the method 1700 is shown in FIG. 17. Generally, the method 1700 starts with a start operation 1702 and ends with an end operation 1716. The method 1700 can include more or fewer operations or stages or can arrange the order of the operations or stages differently than those shown in FIG. 17. The method 1700 can be executed as a set of computer-executable instructions executed by a processor, such as processor 382 of the system 132 or the System 136, and encoded or stored on a computer readable medium. Further, the method 1700 can be performed by gates or circuits associated with a processor, an ASIC, a FPGA, a SOC, or other hardware device. Hereinafter, the method 1700 shall be explained with reference to the systems, components, devices, modules, software, signals, data structures, user interfaces, methods, etc. described in conjunction with FIGS. 1-16 and 18-23; however, it will be understood by those of skill in the art that some or all of the operations of method 1700 can be performed by or using different elements from those described below.

The information parser 604 can receive or retrieve data from multiple sources, in stage 1704. The information parser 604 can access one or more different data sources, including records from DMV datastore(s) 106, court records 108, or other data sources 110 (e.g., telematics, insurance information, or other information). This data is then retrieved from multiple sources. The different data from the multiple sources makes the model more robust and more insightful.

The information parser 604 may then parse out a portion of the data and holdback the data for later verification, in stage 1706. The information parser 604 can select some portion of the data that may be predefined or user specific. This portion of data can be some percentage, for example, 20% of the data, 30% of data, etc. The amount of data held back may be user-defined or may be set based off statistical determinations for verification. The information parser 604 may then store that data as held back data, in data field 910. In some configuration, the information parser 604 can flag the data that is held back, which provides an indication that the data is included in data field 910.

The information parser 604 may then determine if proxy data is required, in stage 1708. Proxy data includes any data that may be needed to fill out or to augment the data retrieved from the data sources. Proxy data, for example, can be data that puts in a default value for certain specific data fields on or about a driver that does not already include that data in the retrieved data. If proxy data is required, the method 1700 proceeds “YES” to stage 1710. In contrast, if proxy data is not needed, the method 1700 proceeds “NO” to stage 1712.

In stage 1710, the information parser 604 can generate proxy data. Generating proxy data includes generating default values or other types of information not contained within the data. This data can be placed in the proxy data field 912 of the model data. Again, proxy data is generated for data that may be missing within the retrieved data.

The data information parser 604 may then group data based on similarities in that data. Data groupings, generated in stage 1712, can be made based off temporal considerations, physical considerations, location considerations, or other types considerations in the data or metadata. Grouped data, for example, can include a group of 5 States with similar licensing requirements. Thus, if the driver is from any of the 5 States, the driver is considered belonging to that group. Other groups can include, for example, types of tickets or for traffic offenses, types of vehicle crashes, types of legal offenses, etc. The group data ensures that the model operates more efficiently. The data groupings are saved in data field 914 by the information parser 604.

The data and the above organizations, provided by the information parser 604, are provided in stage 1714. Here, the information parser 604 can provide the data to the risk score generator 612 to generate the model, as previously described in conjunction FIG. 16.

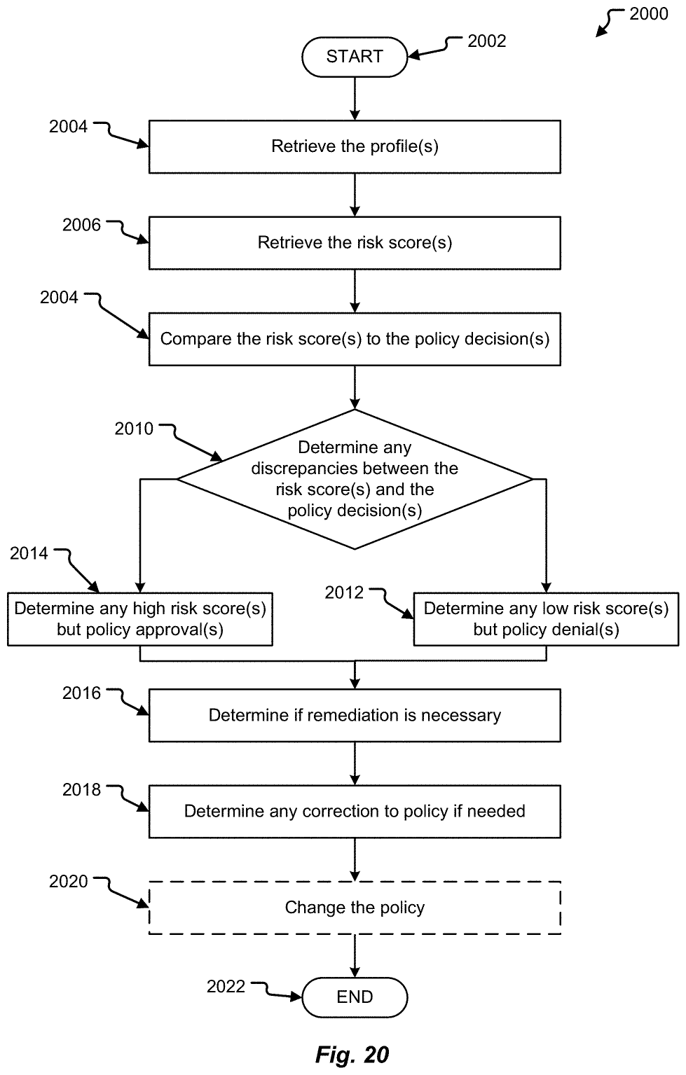

An example of a method 1800 for generating the model using different evaluation periods may be as shown in FIG. 18, in accordance with examples of the present disclosure. A general order for the operations or stages of the method 1800 is shown in FIG. 18. Generally, the method 1800 starts with a start operation 1802 and ends with an end operation 1812. The method 1800 can include more or fewer operations or stages or can arrange the order of the operations or stages differently than those shown in FIG. 18. The method 1800 can be executed as a set of computer-executable instructions executed by a processor, such as processor 382 of the system 132 or the System 136, and encoded or stored on a computer readable medium. Further, the method 1800 can be performed by gates or circuits associated with a processor, an ASIC, a FPGA, a SOC, or other hardware device. Hereinafter, the method 1800 shall be explained with reference to the systems, components, devices, modules, software, signals, data structures, user interfaces, methods, etc. described in conjunction with FIGS. 1-17 and 19-23; however, it will be understood by those of skill in the art that some or all of the operations of method 1800 can be performed by or using different elements from those described below. FIG. 18 may be a more detailed description of some of the processes used to generate the model in stage 1606, as described in conjunction FIG. 16.

The risk score generator 612 can establish an observation period, in stage 1804. The observation period bounds a time frame for what driver data will be used in in generating the model. Generally, observation period may be, for example, a period of time in the past. For example, the observation period can be three years in the past, a period of time from three years ago to six months ago, three consecutive calendar years in the past, etc. The length of time for the observation period can be user-defined, variable, and/or predetermined. The observation period generally determines what weight or value the data needs to have to be considered for the model.

The risk score generator 612 can generate the model during the observation period, in stage 1806. First, the held-back data 910, proxy data 912, and data groupings 914 may be determined. The risk score generator 612 can apply the data, other than the held-back data 910, to one or more algorithms, e.g., a weight of evidence model, etc. The model can create the factors 902, the ranking of factors 906, the correlations 908, etc. with the data used for the observation period. The model may then be verified against the held-back data 910. The model may then determine risk 904 and provide at least a part of the profile for a driver.

The risk score generator 612 may then establish a performance period, in stage 1808. The performance period is a period of time where the model, generated during the observation period, is evaluated for the ability to determine risk effectively and/or efficiently. Risk score generator 612 can establish a period of time, e.g., six months, a year, etc. During this period, the model is run against data coming in about drivers. The amount of time for the performance period can be predetermined, user-defined, variable, and/or fixed. The performance period is some amount of time from the present (after the model is generated) to some future date and time.

The risk score generator 612 may then verify the performance of the model in the performance period, in stage 1810. During the performance period, the risk score generator 612 can use the model to determine risk score for one or more drivers. Then, the risk score generator 612 evaluates whether the high-risk drivers were more likely to have an accident and the low risk drivers were less likely to have an accident. A correlation between the risk scores and the likelihood of accidents is evaluated over a large population of drivers. During this performance period, the risk score generator 612 compares the correlation above to determine if the factors 902, ranking factors 906, and the correlation 908, are correct. Thus, the model may be tested to determine if the model does produce risk scores accurately. If the model is not accurate, then further model generation may occur in a new observation period. If the model is accurate, the verified and proven model is then provided by the risk score generator 612 to the user.

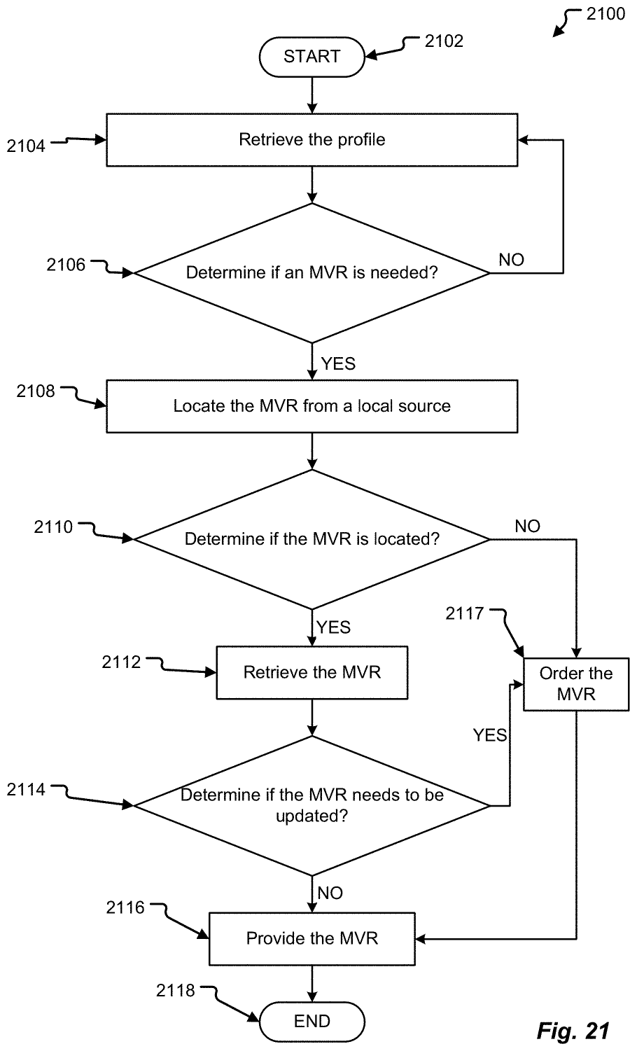

An example of a method 1900 for providing the profile of the user may be as shown in FIG. 19, in accordance with examples of the present disclosure. A general order for the operations or stages of the method 1900 is shown in FIG. 19. Generally, the method 1900 starts with a start operation 1902 and ends with an end operation 1916. The method 1900 can include more or fewer operations or stages or can arrange the order of the operations or stages differently than those shown in FIG. 19. The method 1900 can be executed as a set of computer-executable instructions executed by a processor, such as processor 382 of the system 132 or the System 136, and encoded or stored on a computer readable medium. Further, the method 1900 can be performed by gates or circuits associated with a processor, an ASIC, a FPGA, a SOC, or other hardware device. Hereinafter, the method 1900 shall be explained with reference to the systems, components, devices, modules, software, signals, data structures, user interfaces, methods, etc. described in conjunction with FIGS. 1-18 and 20-23; however, it will be understood by those of skill in the art that some or all of the operations of method 1900 can be performed by or using different elements from those described below.

The risk score generator 612 can retrieve the model, in stage 1904. The model may be included with the model data 900. The model can also include any type algorithms used to generator a risk score. The risk score generator 612 can then be provided data about a driver, in stage 1906. There are many types of inbound data 700 or profile data 1000 that may be provided to the risk score generator 612. The profile generator 620 may then determine a profile for the driver, in stage 1908. Here, the profile generator 620 generates the data structure 1000 and begins storing data in the data structure 1000. The profile can include any type risk score other information dedicated to that driver. This profile can also determine other information or can include items of description of the driver

The risk score generator 612 can determine the risk score for the driver using the model and the provided data, in stage 1910. The risk score can be stored in the profile data 1000 in risk score field 1006. The profile generator 620 may then determine the factors 902 or other information important to the determination of this risk score 1006, in stage 1912. The risk score 1006 and other information may be provided to the profile generator 620 to be stored in the data structure 1000. The risk score generator 612 can also provide the data to the CI generator 610 to generate a CI that indicates the level of confidence in the determined risk score. The CI can also be provided to the profile generator 620 by the CI generator 610 to store in the profile data 1000 in field 1004.

The profile generator 620 can then provide the profile 1000 to a user interface 1200a, in stage 1914. This profile generator 620 generates a user interface and sends it to a display of the user.

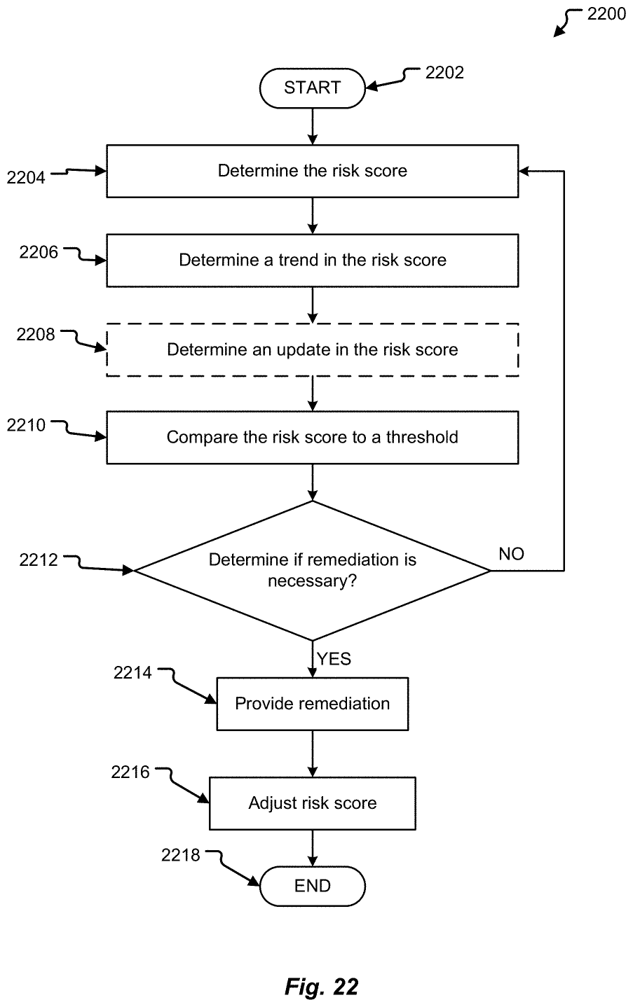

An example of a method 2000 for testing a company policy compared to risk score may be as shown in FIG. 20, in accordance with examples of the present disclosure. A general order for the operations or stages of the method 2000 is shown in FIG. 20. Generally, the method 2000 starts with a start operation 2002 and ends with an end operation 2022. The method 2000 can include more or fewer operations or stages or can arrange the order of the operations or stages differently than those shown in FIG. 20. The method 2000 can be executed as a set of computer-executable instructions executed by a processor, such as processor 382 of the system 132 or the System 136, and encoded or stored on a computer readable medium. Further, the method 2000 can be performed by gates or circuits associated with a processor, an ASIC, a FPGA, a SOC, or other hardware device. Hereinafter, the method 2000 shall be explained with reference to the systems, components, devices, modules, software, signals, data structures, user interfaces, methods, etc. described in conjunction with FIGS. 1-19 and 21-23; however, it will be understood by those of skill in the art that some or all of the operations of method 2000 can be performed by or using different elements from those described below.

The policy correlator 614 can retrieve profiles, such as profile data 1000, in stage 2004. In some configurations, the policy correlator 614 can request the policy and profiles from the profile generator 620. The policy correlator 614 may retrieve any of the profile data 1000 and policy data 800 to compare information between the two data structures.

The policy correlator 614 obtains the risk score 1006 from the profile 1000, in stage 2006. The risk score 1006 identifies the amount risk associated with the driver. The risk score 1006 may be used to determine whether the policy decisions made by the rules in the policy parameters 806 are efficacious. Thus, the policy correlator 614 can compare the risk score 904 to the policy decision, in stage 2004. Here, the risk score is either high, low, or medium. The policy decision was either to grant or not grant insurance or allow or not allow the employee to drive. If the policy indicates something different than what the risk score indicates there may need to be adjustments to the policy.

The policy correlator 614 then can determine there any discrepancies between the risk score 1006 provided and the policy decision, in stage 2010. The comparison can generally look for two types of errors. For example, the policy correlator 614 can determine if the risk score 904 is high but the policy 806 determines approval, in stage 2014. In this case the policy parameters 806 are allowing high-risk drivers. In another example, the policy correlator 614 determines if the risk score 904 is low but the policy parameters 806 deny the driver, in stage 2012. In this case, the policy may be denying low risk drivers. Both different errors in the application of the policy may be identified and then the method 2000 can proceed to stage 2016.

In stage 2016, the policy correlator 614 can determine if any remediation is necessary for the driver. Remediation may include training or other types of interaction or intervention with the driver. Remediation can change the risk score 1006 which can change the correlation or match to the policy decision. After determining remediation, policy correlator 614 can then determine if there is any correction needed to the policy, in stage 2018. The correction to the policy can indicate that the policy parameters 806 are providing inaccurate results or results that do not match the actual risk represented by the risk score 1006. These changes can include changing the rules of when users or drivers are accepted or denied. For example, a driver may be accepted with two traffic tickets which can indicate high-risk, as such, that policy rule may be changed only to allow drivers with one traffic ticket. If any changes are determined to be needed, the policy correlator 614 can make those changes to the policy parameters 806, in stage 2020. Here, the user may provide the changes or these changes may be made automatically based on the ranking of factors 906 associated with the risk score 904. If the policy parameters data 806 allow or deny drivers based on parameters that contradict the ranking of factors 906, those policy parameters 806 can be changed by the policy correlator 614.

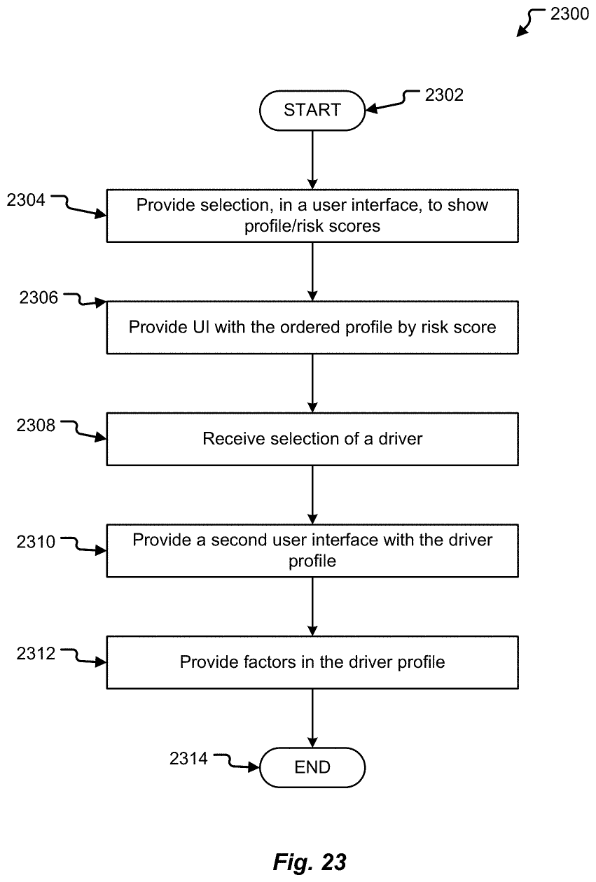

An example of a method 2100 for determining whether to order an MVR may be as shown in FIG. 21, in accordance with examples of the present disclosure. A general order for the operations or stages of the method 2100 is shown in FIG. 21. Generally, the method 2100 starts with a start operation 2102 and ends with an end operation 2118. The method 2100 can include more or fewer operations or stages or can arrange the order of the operations or stages differently than those shown in FIG. 21. The method 2100 can be executed as a set of computer-executable instructions executed by a processor, such as processor 382 of the system 132 or the System 136, and encoded or stored on a computer readable medium. Further, the method 2100 can be performed by gates or circuits associated with a processor, an ASIC, a FPGA, a SOC, or other hardware device. Hereinafter, the method 2100 shall be explained with reference to the systems, components, devices, modules, software, signals, data structures, user interfaces, methods, etc. described in conjunction with FIGS. 1-20 and 22-23; however, it will be understood by those of skill in the art that some or all of the operations of method 2100 can be performed by or using different elements from those described below.

A profile generator 620 may retrieve the profile for driver, in stage 2104. The profile may include information provided in data structures 700, 800, and/or data structure 1000. The profile 1000 can indicate the level of risk 1006 for the driver. This information may be passed to and MVR retriever/matcher 616. The MVR retriever/matcher 616 may then determine if an MVR is needed, in stage 2106. An MVR may be needed if the profile indicates a high risk or a change in the risk level, especially if the risk level increased. Likewise, an MVR may not be needed if the risk score 1006 is low. As such, the MVR retriever/matcher 616 may retrieve an MVR or not retrieve an MVR based on the decision on the amount of risk. If an MVR is needed, the method 2100 proceeds “YES” to stage 2108. If no MVR is needed, the method 2100 proceeds “NO” back to stage 2104 to retrieve another profile.

The MVR retriever/matcher 616 may then locate an MVR in a vault database 130, in stage 2108. The vault database 130 can be a local store of MVRs that were previously retrieved for other reasons or from other searches. The MVR retriever/matcher 616 determines if the driver's identity is within one of the MVR records within the vault database 130. If there is no MVR in the vault database, the MVR retriever/matcher 616 may determine if the MVR is located, in stage 2110. If the MVR is located in the vault database 130, the method 2100 proceeds “YES” to stage 2112. In contrast, if the MVR is not located, the method 2100 proceeds “NO” to stage 2117.

In stage 2112, the MVR retriever/matcher 616 can retrieve the MVR from the vault database 130. The MVR retriever/matcher 616 can read the MVR data and provide that in a user interface to a user. Further, the MVR retriever/matcher 616 may determine if the MVR needs updating, in stage 2114. The MVR retriever/matcher 616 can determine a date or time stamp associated with the MVR. If the date or time stamp is greater than some predetermined threshold, for example, six months, one year, etc., the MVR retriever/matcher 616 may determine that a new MVR needs to be ordered. In other configurations, a change in the risk score 1006 over some threshold can also trigger the MVR retriever/matcher 616 to order a new MVR. If an MVR needs to be updated, the method 2100 may proceed “YES” to stage 2117. However, if no MVR needs to be updated, the method may proceed “NO” to stage 2116, where the MVR retriever/matcher 616 can provide the MVR to the profile generator 620 in stage 2116. If the profile generator 620 can provide a user interface, with the profile and the MVR, to a user. Profile generator 620 can also provide the data in other files or formats or in other means to give to user or to provide to other systems or components.

In stage 2117, the MVR retriever/matcher 616 may then order and MVR from the DMV datastore(s) 106. The MVR retriever/matcher 616 can provide information from or associated with the user data structure 700 to provide to the DMV datastore 106. The MVR Orderer may be sent, by the MVR retriever/matcher 616, electronically. The DMV datastore 106 can send an electronic MVR back to the MVR retriever/matcher 616 as a reply message. This ordered MVR may then be provided to the profile generator 620 to be provided to the user, other components, etc., in stage 2116.

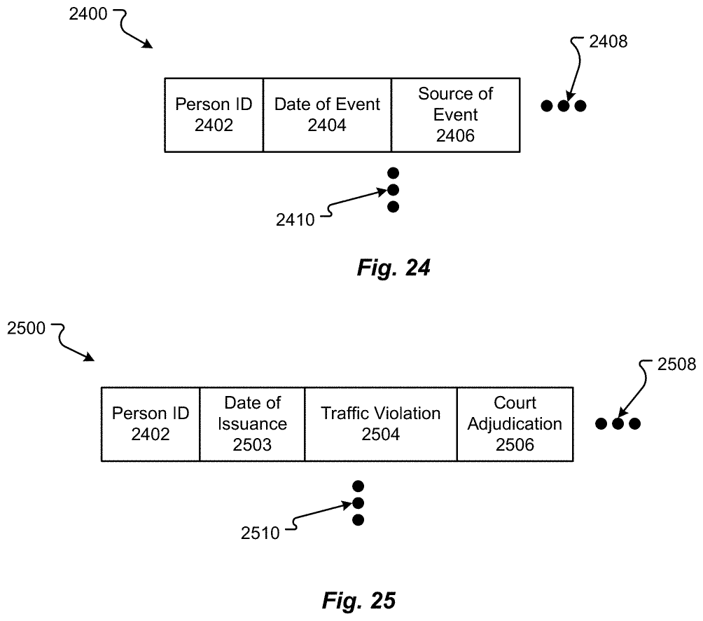

An example of a method 2200 for determining that remediation should be given to driver may be as shown in FIG. 22, in accordance with examples of the present disclosure. A general order for the operations or stages of the method 2200 is shown in FIG. 22. Generally, the method 2200 starts with a start operation 2202 and ends with an end operation 2218. The method 2200 can include more or fewer operations or stages or can arrange the order of the operations or stages differently than those shown in FIG. 22. The method 2200 can be executed as a set of computer-executable instructions executed by a processor, such as processor 382 of the system 132 or the System 136, and encoded or stored on a computer readable medium. Further, the method 2200 can be performed by gates or circuits associated with a processor, an ASIC, a FPGA, a SOC, or other hardware device. Hereinafter, the method 2200 shall be explained with reference to the systems, components, devices, modules, software, signals, data structures, user interfaces, methods, etc. described in conjunction with FIGS. 1-21 and 23; however, it will be understood by those of skill in the art that some or all of the operations of method 2200 can be performed by or using different elements from those described below.

The risk score generator 612 may determine a risk score 1006 associated with the driver, in stage 2204. The risk score generator 612 may use the model information 900 to determine a risk score 1006 based on inbound data 700. Thus, the risk score generator 612 can analyze the driver's past behavior using the model to determine the risk score 1006. This generation of a risk score can be completed periodically by the risk score generator 612. The risk score generator 612 may then determine if there is a trend to the risk score 1006 based on two or more past risk scores 1006, in stage 2206. The risk score generator 612 can do statistical analysis on the changes in the risk score 1006 to determine if the risk score is making a statistically significant change over a period of time. Optionally, if the risk score trend is statistically significant, the risk score generator may determine to update in the risk score 1006 with the most current data, in stage 2208. The update can include rerunning the risk score analysis based on the newest information in data structure 700 or from other sources.

The latest or updated risk score 1006 can then be compared to a predetermined threshold, in stage 2210. Here, the remediation determiner 618 can receive the latest risk score 1006 from risk score generator 612. The remediation determiner 618 can compare this risk score 1006 to some type of predetermined threshold set by the user, company, etc. If the risk score 1006 is below the predetermined threshold 808, the remediation determiner 618 may determine that remediation is necessary. If no remediation is necessary, the method 2200 proceeds “NO” back to stage 2204 to determine the risk score 1006 of a new driver or a new risk score for this driver. However, if remediation is necessary, the method 2200 proceeds “YES” to stage 2212

In stage 2212, the remediation determiner 618 can determine what type of remediation is necessary. Here, based on the risk score 904 and the remediation threshold 808, the remediation determiner 618 can choose from one or more remediation matches 810 for the type of remediation to provide to the driver. The suggestion for mediation may be provided to a company or other user by the remediation determiner 618. This remediation may be provided to the driver, in stage 2214. After the remediation, the risk score 1006 may be re-determined and/or adjusted by the risk score generator 612, in stage 2216. Past remediation may indicate the expected changes in driver behavior and whether those drivers should increase or decrease the risk score 1006. This remediation information, based on past behavior of other drivers, can indicate a level of change for the risk score 1006 for this driver after remediation. This risk score 1006 can then be reevaluated in the method 2200 to determine if more remediation is necessary or other remediation provided has changed the risk score enough to determine the driver needs no more remediation.

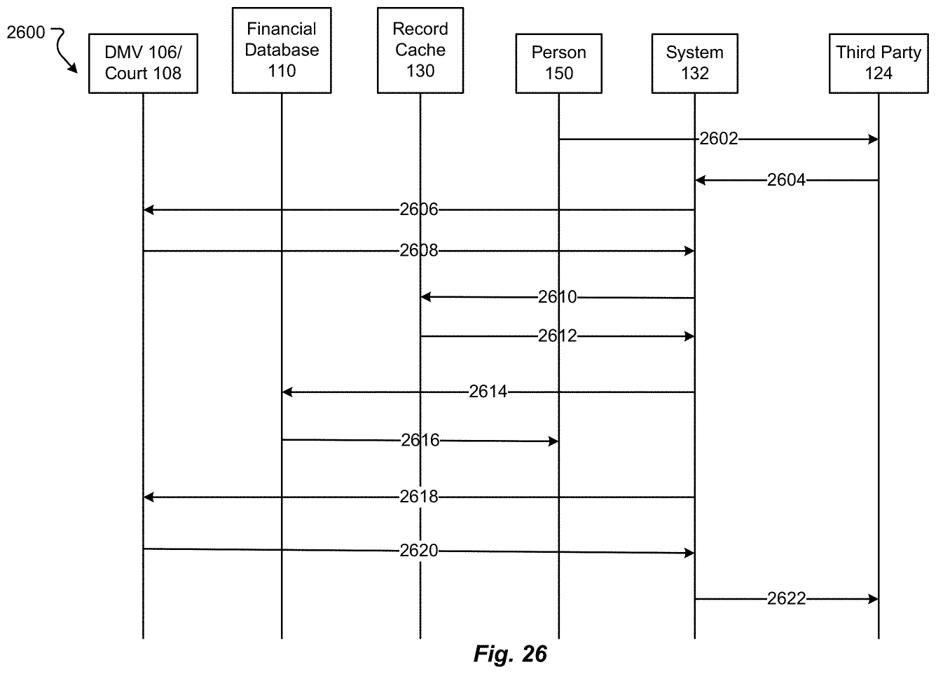

An example user interface method 2300 may be as shown in FIG. 23, in accordance with examples of the present disclosure. A general order for the operations or stages of the method 2300 is shown in FIG. 23. Generally, the method 2300 starts with a start operation 2302 and ends with an end operation 2314. The method 2300 can include more or fewer operations or stages or can arrange the order of the operations or stages differently than those shown in FIG. 23. The method 2300 can be executed as a set of computer-executable instructions executed by a processor, such as processor 382 of the system 132 or the System 136, and encoded or stored on a computer readable medium. Further, the method 2300 can be performed by gates or circuits associated with a processor, an ASIC, a FPGA, a SOC, or other hardware device. Hereinafter, the method 2300 shall be explained with reference to the systems, components, devices, modules, software, signals, data structures, user interfaces, methods, etc. described in conjunction with FIGS. 1-22; however, it will be understood by those of skill in the art that some or all of the operations of method 2300 can be performed by or using different elements from those described below.

The systems 132/136 can provide a user interface that allows for the retrieval of risk scores and driver profiles. For example, the system 132 may provide user interface (e.g., user interface 1200a with selections list 1236). These user selectable words may provide a user interface 1200a, in response to an interaction with a user through the user interface. For example, if the word “People” is selected, the risk score listings 1218, shown in FIG. 12A, may be provided.

Based on some type of user interface interaction, the profile generator 620 or other component can provide a user interface 1200a to show profiles and risk scores in a user interface, in stage 2306. The profile generator 620 may produce the user interface 1200a as shown in FIG. 12A. Here, a list of the drivers 1218 with name shown in column 1224 may be provided and ordered based on risk as provided in column 1220. The list 1218 may allow for selection of one or more of the drivers. For example, if the user uses a user interface device to select one of the names, which include a different visual indicia indicating that the name may be selected, a separate user interface 1200b may then be provided. User interface 1200a may then receive a selection of a driver based on user interaction with the name, in stage 2308.

In response to the selection of a driver, the profile generator 620 may provide user interface 1200b to the user. For example, if the user selects “Chris Smith” from column 1224 in user interface 1200a, then the user interface 1200b, indicating information about “Christopher Smith,” may be shown in the user interface 1200b. Thus, the profile generator 620 can provide the second user interface 1200b of the driver profile, in stage 2310. The driver profile can include information as shown in FIG. 12B, including providing factors in portion 1214 associated with the driver profile, in stage 2312. Here, the factors may include the list in portion 1214 and the associated points assigned thereto in column 1215. These factors in portion 1214 indicate why the risk score 1210 is high and may also be used to base any type of remediation for the driver.

An implementation of the data structure 2400 that may include outbound data may be as shown in FIG. 24. Outbound data 2400 can include any data provided or retrieved from or by a third party system 124, as described in conjunction with FIG. 1. Outbound data 2400 can also represent any data received by a person 150. The outbound data 2400 can include one or more of, but is not limited to, a person identifier (ID) 2402, a date of an event 2404, and/or source of the event 2406. There may be more or fewer fields, in the outbound data, as represented by the ellipses 2408. Each driver or employee may have a different set of outbound data associated therewith, and thus, there may be more data structures 2400 than those shown in FIG. 24, as represented by ellipses 2410.

Person ID 2402 can be the same or similar to driver ID 702. Thus, the person ID 2402 can be any type of identification of the driver. This person ID 2402 can include, for example, the driver's name, the driver's address, the driver's Social Security number, the driver's license number, a uniquely created identifier (for example, an alphanumeric identifier, a globally unique identifier (GUID), etc.), vehicle identification, or other types of identifiers. This person ID 2402 uniquely identifies this driver amongst other drivers within the system. The person ID 2402 can also be two or more different items of information that may be used in conjunction to determine the identity of the driver.

The date of event 2404 can include any date and/or time information associated with an event associated with the license. The date of an event 2404 can include a year, day, hour, minute, etc. The event can be any type of indication that the person 150 had a license at the time of the event. For example, the date of issuance of the license, the date of a ticket, the date that a court adjudicated traffic violation, etc., can indicate that the person had a license at that date. The date of the event can indicate the earliest licensure for the person 150.

The source of event 2406 can be any information about where the date of event 2404 was found. For example, source of the event 2406 can include a name, address, or other information about state MVR datastore, state court database, or other types of sources of traffic violation or other information. Further, the source of event 06 can also include the record information as the source. For example, the source of event 2406 can be the name, date, or other information associated with an MVR. The source of event 2406 allows the third party system 124 to understand the context of the information and about how a length of licensure may be computed from the date of event 2404.

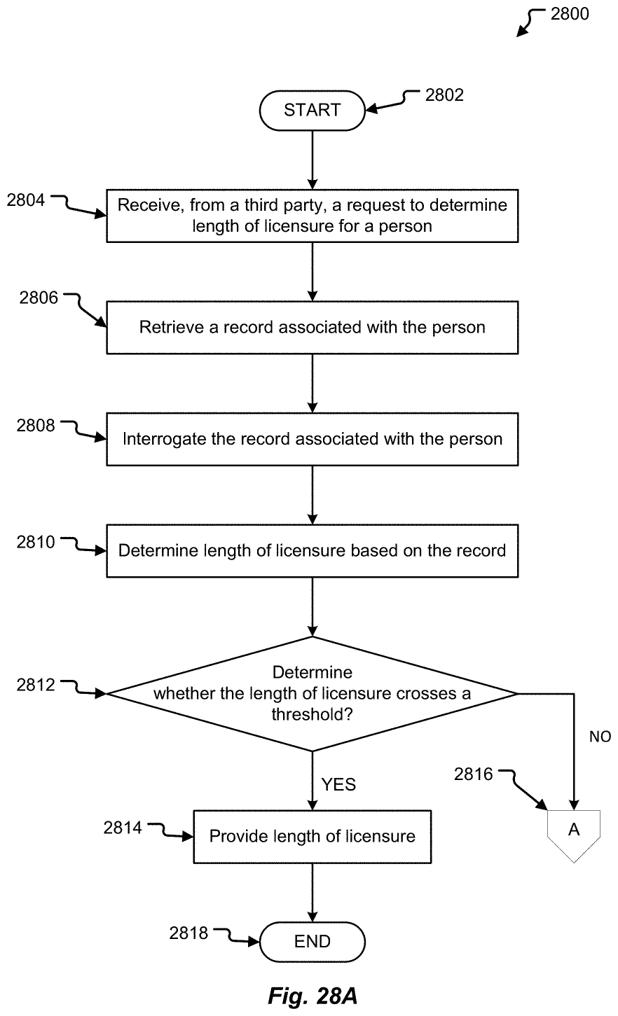

An implementation of the data structure 2500 that may include inbound data may be as shown in FIG. 25. Inbound data 2500 can include any data provided or retrieved from or by the system 132, as described in conjunction with FIG. 1. Inbound data 2500 can also represent any data received from a person 150. The inbound data 2500 can include one or more of, but is not limited to, a person identifier (ID) 2502, a date of issuance 2503, a traffic violation 2504, and/or a court adjudication 2506. There may be more or fewer fields, in the inbound data, as represented by the ellipses 2508. Each driver or employee may have a different set of inbound data associated therewith, and thus, there may be more data structures 2500 than those shown in FIG. 25, as represented by ellipses 2510. Person ID 2502 can be the same or similar to Person ID 2502, as described in conjunction with FIG. 25, and thus, will not be explained further here.

The date of issuance 2503 can be a first source of information and a date of the length of licensure. A person's driver's license includes a date on which the driver's license was issued. In at least some situations, the state MVR datastore 106 includes the date of issuance 2503 in the MVR provided from that database. The date of issuance 2503 can indicate a length of licensure for a person 150.

A traffic violation 2504 can be some indication that a traffic law or other type of law was broken by the person 150. For example, the traffic violation 2504 can be a speeding ticket, can be a driving while under the influence charge, can be a nonmoving moving violation, can be a parking ticket, can be some other type of violation associated with driving. In some situations, traffic violation 2504 can also indicate other types of crimes where an ID may be used as an indication of the person's identity. Regardless, the traffic violation 2504 can indicate the type of violation. For example, the traffic violation 2504 can include the charge asserted against the person 150 and the date upon which that ticket was issued. This way, it is possible to determine the length of licensure based on the inference that the traffic violation 2504 suggests that person 150 must have had a driver's license at that time.

A court adjudication 2506 can be any type of court action associated with the traffic violation. Thus, the court adjudication 2506 can be an indication of the date for a court hearing associated with the traffic ticket, a date when a punishment was issued from a court, or other types of dates associated with any court action. The court action is associated with the traffic law then it can be inferred that the person had a driver's license at the time the court action occurred. The court adjudication information 2506 can include the type of court action, the date upon which it occurred, etc. The length of licensure can then be determined from the date of the court action.

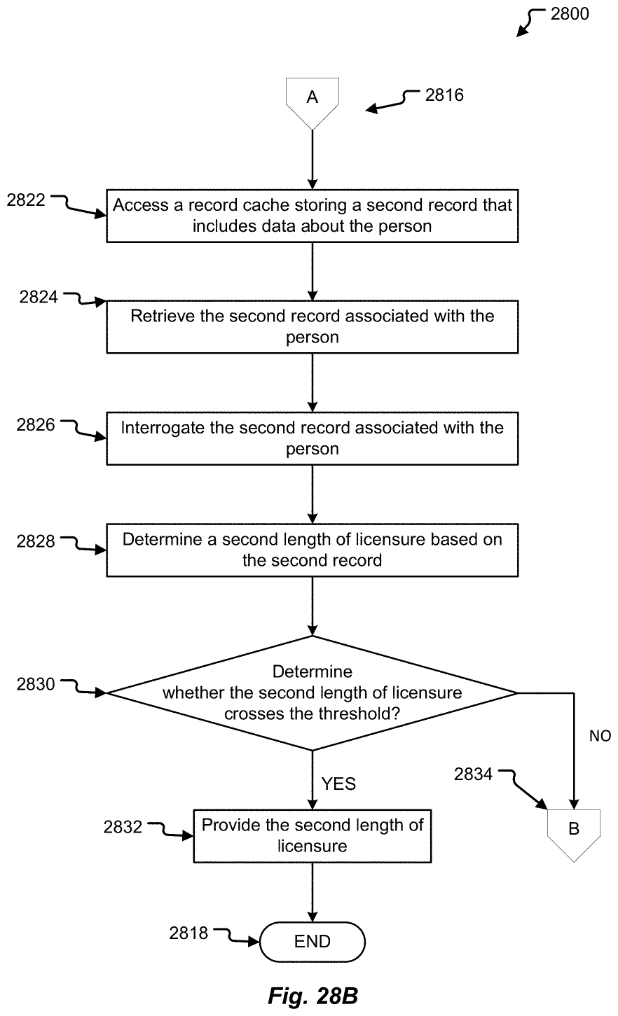

An example of a signaling diagram or process 2600 may be as shown in FIG. 26. The diagram 2600 shows signals being sent between the DMV datastore 106, of at least one State, and/or the court system 108, of at least one State, other data sources 110 (possibly, a financial database), a records cache 130, a system 136/132, a person 150, and/or an third party system (e.g., an employer system) 124/128.

In a first signal 2602, a person 150 may contact a third party system 124, e.g., access an application executed at an employer website. The person 150 may send driver's license information and/or other biographical information in signal 2602. The third party system 124 may then send signal 2604 to the system 132 to request a length of licensure for the person 150. Signal 2604 can include the biographical information received from the person 150. The system 132 may then request information from a data source, e.g., the state databases 152, in signal 2606. The request signal 2606 can request a record with the information from the person 150.

Signal 2608 sends data from the state database 152, e.g., the DMV datastore 106 or the court 108, to the system 132. The data in signal 2608 may be inbound data 2500 or other data as described herein. The system 132 may also receive settings or other information from the employer and/or the third party system 124. Further, the employer may also send the policy data, for example, a threshold desired from the length of licensure. The system 132 may then use some or all of the received data to determine a length of licensure for the person 150 and whether the length of licensure crosses the threshold. If the length of licensure does not cross the threshold, the system 132 may access other sources of information.

The system 132 may then access information from a record cache 130, with signal 2610. The request signal 2610 can request an older record with the information from the person 150. Signal 2612 sends data from the record cache 130 to the system 132. The data in signal 2612 may be similar to inbound data 2500 or other data as described herein. The system 132 may then use some or all of the data from the record cache to determine a length of licensure for the person 150 and whether the length of licensure crosses the threshold. If the length of licensure does not cross the threshold, the system 132 may again access other sources of information.

The system 132 may then request information from a financial entity database 110, with signal 2614. The request signal 2614 can request any information about a license used in an application for a financial instrument, e.g., a loan. Signal 2616 sends data from a financial entity database 110 to the system 132. The data in signal 2616 may include information about a license used for a financial application. The system 132 may then use some or all of the data from the financial database to determine one or more other states to which the person 150 had a license. Based on the information from the financial database, the system 132 may again access other sources of information.

The system 132 may then access information from a second state database 152, e.g., the DMV datastore 106 or the court 108, with signal 2610. The state database(s) can return the requested data as new records, e.g. MVR(s), in signal 2620. The data in signal 2620 may again be similar to inbound data 2500 or other data as described herein. The system 132 may then use some or all of the received data to determine a length of licensure for the person 150 and whether the length of licensure crosses the threshold. If the length of licensure does not cross the threshold, the system 132 may indicate to the third party in signal 2622, that no information could be found that indicated the person 150 had a length of licensure that crosses the threshold.

However, if any of the information located from any source indicates that the person 150 had a length of licensure that crosses the threshold, the system 132 can send, in signal 2622, information about the licensure. The data in signal 2622 can be similar to the outbound data 2400 or other data as described herein. The third party system 124 can receive signal 2622. The various signals 2602 through 2622 may occur in less than a minute, in under 10 seconds, in under one second, etc. Thus, while the person 150 is still interacting with the third party system 124, e.g., continues to interact with the application of the third party system 124, the third party system 124 can receive signal 2622 indicating if the person 150 qualifies as a driver, e.g., their length of licensure crosses the threshold.

It should be noted that still other sources of licensure information may be accessed after signal 2620 is received. For example, the system 132 may access information about a CDL associated with the person. The system 132, therefore, can access information about other licenses the person 150 may have. Still other sources of data may be available to the system 132. Thus, the system 132 can continue to access other data sources 110 until a determination about the length of licensure is resolved. The CDL data provided to the third party system 124 can includes information from more than one state (e.g., three states) in which the person was issued the CDL.

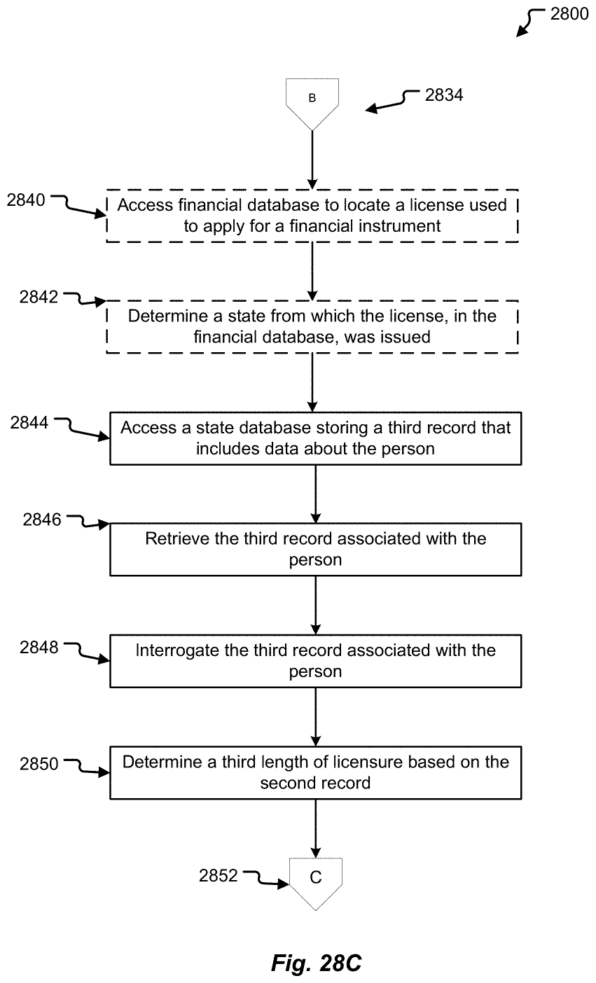

An example method 2700 for determining a length of licensure may be as shown in FIG. 27, in accordance with examples of the present disclosure. A general order for the operations or stages of the method 2700 is shown in FIG. 27. Generally, the method 2700 starts with a start operation 2702 and ends with an end operation 2714. The method 2700 can include more or fewer operations or stages or can arrange the order of the operations or stages differently than those shown in FIG. 27. The method 2700 can be executed as a set of computer-executable instructions executed by a processor, such as processor 382 of the system 132 or the system 136, and encoded or stored on a computer readable medium. Further, the method 2700 can be performed by gates or circuits associated with a processor, an ASIC, a FPGA, a SOC, or other hardware device. Hereinafter, the method 2700 shall be explained with reference to the systems, components, devices, modules, software, signals, data structures, user interfaces, methods, etc. described in conjunction with FIGS. 1-26. However, it will be understood by those of skill in the art that some or all of the operations or stages of method 2700 can be performed by or using different elements from those described below.

The system 132 can receive a request signal 2604, from a third party system 124, e.g., an employer, to determine a length of licensure, in stage 2704. The identity discoverer 602 can determine the identity of the person 150 based on information provided by the person 152 and the third party system 124. For example, the person 150 may interact with the third party 124 through an application. The person 150 may apply for a job with the third party 124 using an application to provide employment information to the third party 124. While the person 150 is still engaging the third party 124 through the application, the third party 124 may send the biographical information to the system 132.

The information provided can include biographical information, for example, the user's current driver's license information. The biographical information may be parsed to determine identity information that can be used to access data stores. This information may be then passed to the information locator/matcher 606.

In some implementations, the risk score generator 612 can determine the length of licensure for the person 150 based off of this initial biographical information. Further, the policy correlator 614 may have received a recorded threshold for length of licensure from the third party system 124. If the current length of licensure crosses the received threshold, policy correlator 614 may indicate that person has the required licensure by sending such indication to the third party system 124. However, in other implementations, the information locator/matcher 606 must access other data stores.

The system 132 can access two or more data stores 106-110, 152 for data regarding a person 150 associated with licensure, in stage 2706. The information locator/matcher 606 may access at least one of two or more data stores 106-110, 152. For example, the information locator/matcher 606 may access the state databases 152. The databases or data stores that may be accessed can include a DMV datastore 106, the court database 108, financial entity database 110, other types of databases 110 and/or other types of state databases 152. Each of the different types of databases or systems may have a separate interface to interact with the database, system, third party, etc. For example, a first interface 402 may interact with the third party 124. A DMV or MVR datastore may be access through a database interface 402. A record cache 130 may be interface with record cache interface 402. The other data sources, such as the financial entity database 110, may be accessed through a financial database interface 402. Court systems may be interfaced through a court database interface 402. These interfaces may be similar and contain the appropriate interaction code to access and retrieve information from the several sources. The information locator/matcher 606 or an MVR retriever/matcher 616 may then retrieve a record from one of the two or more databases/datastores 106-152. The record may then be provided to the risk score generator 612.

The system 132 can interrogate a record, e.g., an MVR information 708, associated with the person 150 accessed from one of the two or more data stores 106-110, 152, in stage 2708. A profile generator 620 may interrogate the record retrieved from the data source. Interrogating the record can include looking for an indication of licensure for the person 150. Indication of licensure can be any type of event that can or is likely to have occurred based on the person 150 already having a driver's license. For example, the indication of licensure can include the issuance of a license and the associated date of issuance of the license, a traffic violation (other than a driving without a license violation), an adjudication of a traffic violation (other than driving without a license), or other type of event. The indications of an event that indicates licensure may be the same or similar to data structure 2500 as is shown in FIG. 25. These offenses occur based on the person 150 having a license. If one of these offenses is listed in the interrogated record, the profile generator 620 can extract a date associated with the event, and the state of the event source, to which this information was located, and may assemble them into an output.

If an indication of licensure is located the record, the system 132 can determine a length of licensure, in stage 2710. Thus, the risk score generator 612 may receive the information from the interrogated record retrieved from one or more of the several data sources to determine the earliest event that indicates licensure. Based on the earliest event, the risk score generator 612 can determine the length of licensure. In other situations or implementations, the risk generator 612 may compare the date of the event or length of the licensure, computed from the current date to the date of the event, to a threshold provided by the third party 124. If the length of license third crosses the threshold or indicates a length of licensure greater than the threshold. The system 132 can indicate this information to the third party 124.

The system 132 can provide the length of licensure to the third party system 124, in stage 2712. The profile generator 620 may then communicate a length of licensure to the third party 124 based on the information provided about the event. The output may be sent to the third party 124 through third party interface 402. The information included in the output may be the same or similar to data structure 2400 as shown in FIG. 24. The output can include the date of the event and the source of the event. The output can indicate an earliest indication of licensure found by the system 132. In implementations, less than one minute may elapse between the reception of the request for length of licensure and the profile generator 620 communicating the late length of licensure back to the third party 124. In other implementations the communication of the length of licensure can take 10 seconds or less after receiving the request. Regardless, the communication of the length of licensure back to the third party 124 can occur while the person 150 continues to interact with the application executed by the third party system 124.

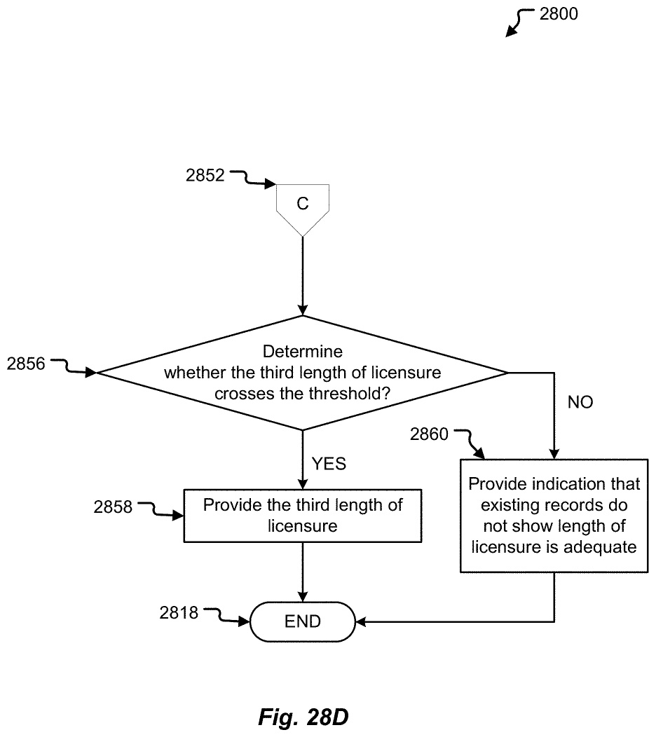

An example method 2800 for determining a length of licensure may be as shown in FIGS. 28A-28D, in accordance with examples of the present disclosure. A general order for the operations or stages or stages of the method 2800 is shown in FIG. 28. Generally, the method 2800 starts with a start operation 2804 and ends with an end operation 2818. The method 2800 can include more or fewer operations or stages or can arrange the order of the operations or stages differently than those shown in FIG. 28. The method 2800 can be executed as a set of computer-executable instructions executed by a processor, such as processor 382 of the system 132, and encoded or stored on a computer readable medium. Further, the method 2800 can be performed by gates or circuits associated with a processor, an ASIC, a FPGA, a SOC, or other hardware device. Hereinafter, the method 2800 shall be explained with reference to the systems, components, devices, modules, software, signals, data structures, user interfaces, methods, etc. described in conjunction with FIGS. 1-27. However, it will be understood by those of skill in the art that some or all of the operations of method 2800 can be performed by or using different elements from those described below.

The system 132 can receive, from a third party system 124, a request to determine length of licensure for a person 150, in stage 2804. The identity discoverer 602 can determine the identity of the person 150 based on information provided by the person 152 to the third party system 124. For example, the person 150 may interact with the third party 124, through an application. For example, the person 150 may apply for a job with the third party 124 using an application to provide employment information to the third party 124. While the person 150 is still engaging the third party 124 through the application, the third party 124 may send the biographical information to the identity discoverer of the system 132. The information provided can include biographical information, for example, the user's current driver's license information. The biographical information may be parsed and evaluated to determine identity information that can be used to access data stores. This information may be then passed to the information locator/matcher 606.

In some implementations, the risk score generator 612 can determine the length of licensure for the person 150 based off of this initial biographical information. Further, the policy correlator 614 may have received a recorded threshold for length of licensure from the third party system 124. If the current length of licensure crosses the received threshold, policy correlator 614 may indicate that person has the required licensure by sending such indication to the third party system 124. However, in other implementations the information locator/matcher 606 must access other data stores.

The system 132 can retrieve a record associated with the person, in stage 2806. The system 132 can access two or more data stores 106, 108, 152 for data regarding a person 150 associated with licensure. The information locator/matcher 606 may access at least one of two or more data stores 106, 108, 152. For example, the information locator/matcher 606 may access the state database(s) 152. The databases or data stores that may be access can include a DMV datastore 106, the court database 108, and/or other types of state databases 152. Each of the different types of databases or systems may have a separate interface to interact with the database system of a third party. The information locator/matcher 606 or an MVR retriever/matcher 616 may then retrieve a record from one of the databases/datastores 106, 108, 152. The record retrieved may include a current MVR or record associated with the person's current information. The record may then be provided to the risk score generator 612.

After retrieving the current record, e.g., a current MVR INFORMATION 708, the system 132 can interrogate the record associated with the person 150, in stage 2808. A profile generator 620 may interrogate the current record retrieved from the data source. Interrogating the record can include looking for an indication of licensure for the person 150. Indication of licensure can be any type of event that can or is likely to have occurred based on user already having a driver's license. For example, the indication of licensure can include the issuance of a license and the associated date of issuance of the license, a traffic violation (other than a driving without a license violation), an adjudication of a traffic violation (other than driving without a license), or other type of event. The indications of an event that indicates licensure may be the same or similar to data structure 2500 as is shown in FIG. 25. These events may only occur based on the user having a license. If one of these offenses is listed in the interrogated record, the profile generator 620 can extract date associated with the event and the type of the event source to which this information was located, and then this information may be assembled into an output.

The system 132 may then determine length of licensure based on the record, in stage 2810. If an indication of licensure is located in the record, the system 132 can determine a length of licensure. Thus, the risk score generator 612 may receive the information from the interrogated record retrieved from one or more of the state data sources to determine the earliest event that indicates licensure. Based on the earliest event, the risk score generator 612 can determine the length of licensure. The risk generator 612 may then compute the date of the event or length of the licensure from the current date to the date of the event to determine the length of licensure. The solution of this computation is a first length of licensure.

The system 132 may then determine whether the first length of licensure crosses a threshold, in stage 2812. The risk generator 612 can receive a threshold provided by the third party 124. The risk generator 612 can compare the first length of licensure to the received threshold to determine if the first length of licensure crosses the threshold. If the length of license crosses the threshold or indicates a length of licensure greater than the threshold, the method 2800 proceeds YES to stage 2814 where the system 132 can provide or indicate this first length of licensure information to the third party 124. If the length of license does not cross the threshold, the method 2800 proceeds NO to off-page connector 2816 to stage 2822.

The system 132 can provide length of licensure, in stage 2814. The profile generator 620 may then communicate a length of licensure to the third party 124 based on the information provided about the event. The output may be sent to the third party 124 through third party interface 402. The information included in the output may be the same or similar to data structure 2400, as shown in FIG. 24. The output can include the date of the event and the source of the event. The output sent may not be the earliest indication of licensure found by the system 132 but can show that the first length of licensure is more than the third party's requirements as the first length of licensure crosses the threshold. In implementations, less than one minute may elapse between the reception of their request for length of licensure and the profile generator 620 communicating the first length of licensure back to the third party 124. In other implementations the communication of length of licensure can take 10 seconds or less after receiving the request. The communication of the length of licensure back to the third party 124 can occur while the person 150 continues to interact with the application executed by the third party system 124.

In stage 2822, the system 132 can access a record cache storing a second record that includes data about the person, in stage 2822. The system 132 can access a record cache 130 for older data regarding a person 150 associated with licensure that may have been previously stored by the data platform 104. The information locator/matcher 606 may access the record cache 130. The record cache 130 may store older MVRs that were retrieved previously, based on a previous interaction of the person 150 with a third party that requested information from the system 132. The record cache 130 may be accessed through a record cache interface to interact with the record cache.

The system 132 can then retrieve the second (cached) record associated with the person 150, in stage 2824. The information locator/matcher 606 or an MVR retriever/matcher 616 may then retrieve a record from the record cache 130. The record retrieved may include a previously-stored MVR or record associated with the person's current information. The record may then be provided to the risk score generator 612.

The system 132 can then interrogate the second record associated with the person, in stage 2826. The profile generator 620 may then interrogate the older record retrieved from the record cache 130. Interrogating the cached record can again include looking for an indication of licensure for the person 150. Indication of licensure can be any type of event that can or is likely to have occurred based on user already having a driver's license. For example, the indication of licensure can include the issuance of a license and the associated date of issuance of the license, a traffic violation (other than a driving without a license violation), an adjudication of a traffic violation (other than driving without a license), or other type of event. The indications of an event that indicates licensure may be the same or similar to data structure 2500 as is shown in FIG. 25. These events may only occur based on the user having a license. If one of these offenses is listed in the interrogated record, the profile generator 620 can extract date associated with the event and the type of the event source to which this information was located, and then this information may be assembled into an output.

From the interrogated older record, the system 132 may then determine a second length of licensure based on the second cached record, in stage 2828. If a cached record is located and an indication of licensure is located in the cached record, the system 132 can determine a second length of licensure. Thus, the risk score generator 612 may receive the information from the interrogated record retrieved from record cache 130 to determine the earliest event that indicates licensure. Based on the earliest event, the risk score generator 612 can determine the second length of licensure. The risk generator 612 may then compute the date of the event or second length of the licensure from the current date to the date of the event to determine the second length of licensure. The solution of this computation is a first length of licensure.

The system 132 may then determine whether the computed second length of licensure crosses the received threshold, in stage 2830. The risk generator 612 can retrieve the threshold provided by the third party 124. The risk generator 612 can compare the second length of licensure, determined from the cached record, to the received threshold to determine if the second length of licensure crosses the threshold. If the second length of licensure crosses the threshold or indicates a length of licensure greater than the threshold, the method 2800 proceeds YES to stage 2832, where the system 132 can provide or indicate this second length of licensure information to the third party 124. If the second length of license does not cross the threshold, the method 2800 proceeds NO to off-page connector 2834 to stage 2840.

The system 132 can provide the second length of licensure, in stage 2832. The profile generator 620 may then communicate the second length of licensure to the third party 124 based on the information from the record cache 130. The output may be sent to the third party 124 through third party interface 402. The information included in the output may be the same or similar to data structure 2400, as shown in FIG. 24. The output can include the date of the event and the source of the event, e.g., a cached record. The output sent may not be the earliest indication of licensure found by the system 132 but can show that the second length of licensure is more than the third party's requirements as the second length of licensure crosses the threshold. Again, in implementations, less than one minute may elapse between the reception of their request for length of licensure and the profile generator 620 communicating the second length of licensure back to the third party 124. In other implementations the communication of second length of licensure can take 10 seconds or less after receiving the request. The communication of the second length of licensure back to the third party 124 can occur while the person 150 continues to interact with the application executed by the third party system 124.

In stage 2840, the system 132 can access a financial entity database 110 to locate a license used to apply for a financial instrument, in stage 2840. The system 132 can access a financial entity database 110 for an indication that the person 150 used a license to apply for a financial instrument, e.g., a home loan, a car loan, a bank account, etc. The information locator/matcher 606 may access the financial entity database 110. The financial entity database 110 may store a transaction history associated with the person 150 that documents the person's financial history. At least one transaction in the transaction history may indicate that the person 150 used a driver's license to apply for credit or another financial instrument. That transaction may be interrogated by the information locator/matcher 606. The financial entity database 110 may be accessed through a financial database interface to interact with financial entity database 110.

The system 132 can then determine a state from which the license, in the financial database, was issued, in stage 2842. The information locator/matcher 606 can interrogate the transaction in the financial entity database 110. The state indicated in the license information may be retrieved from the transaction information. The one or more states, associated with a financial transaction that used a driver's license, may be provided by the information locator/matcher 606.

The system 132 can then access a state database (that may be different from the state database used to obtain the original record) storing a third record that includes data about the person, in stage 2844. The state database 152 accessed by the information locator/matcher 606 for data regarding the person 150 associated with licensure. The information locator/matcher 606 may access at least one of two or more data stores 106, 108, 152 associated with the state located in the financial entity database 110. For example, the information locator/matcher 606 may access the state database(s) 152. The databases or data stores that may be accessed can include a DMV datastore 106, the court database 108, and/or other types of state databases 152. Each of the different types of databases or systems may have a separate interface to interact with the database system of a third party. The information locator/matcher 606 can attempt to locate a third record associated with the person 1520 from the different state's database.

The system 132 may then retrieve the third record associated with the person, in stage 2846. The information locator/matcher 606 or an MVR retriever/matcher 616 may then retrieve a record from one of the databases/datastores 106, 108, 152. The record retrieved may include the third record, e.g., a new state MVR, associated with the person's previous license. The third record may then be provided to the risk score generator 612.

In stage 2848, the system 132 can interrogate the third record associated with the person 150. A profile generator 620 may interrogate the third record retrieved from the different state's data source(s). Interrogating the record can include looking for an indication of licensure for the person 150. Indication of licensure can be any type of event that can or is likely to have occurred based on user already having a driver's license. For example, the indication of licensure can include the issuance of a license and the associated date of issuance of the license, a traffic violation (other than a driving without a license violation), an adjudication of a traffic violation (other than driving without a license), or other type of event. The indications of an event that indicates licensure may be the same or similar to data structure 2500 as is shown in FIG. 25. These events may only occur based on the user having a license. If one of these offenses is listed in the interrogated third record, the profile generator 620 can extract a date associated with the event and the type of the event source to which this information was located, and then this information may be assembled into an output.

The system 132 can then determine a third length of licensure based on the second record, in stage 2850. If an indication of licensure is located in the third record, the system 132 can determine a third length of licensure. Thus, the risk score generator 612 may receive the information from the interrogated third record retrieved from the different state's data sources to determine the earliest event that indicates licensure. Based on the earliest event, the risk score generator 612 can determine the third length of licensure. The risk generator 612 may then compute the date of the event or third length of the licensure from the current date to the date of the event to determine the third length of licensure. The solution of this computation is the third length of licensure. The method 2800 may then proceed through off-page connector 2852 to stage 2856.

Then, the system 132 can determine whether the third length of licensure crosses the threshold, in stage 2856. The risk generator 612 can receive the threshold provided by the third party 124. The risk generator 612 can compare the third length of licensure to the received threshold to determine if the third length of licensure crosses the threshold. If the third length of license crosses the threshold or indicates a third length of licensure greater than the threshold, the method 2800 proceeds YES to stage 2858 where the system 132 can provide or indicate this third length of licensure information to the third party 124. If the length of license does not cross the threshold, the method 2800 proceeds NO to stage 2860.

The system 132 can provide the third length of licensure, in stage 2858. The profile generator 620 may then communicate the third length of licensure to the third party 124 based on the information provided about the event in the third record. The output may be sent to the third party 124 through third party interface 402. The information included in the output may be the same or similar to data structure 2400, as shown in FIG. 24. The output can include the date of the event and the source of the event. The output sent may not be the earliest indication of licensure found by the system 132 but can show that the third length of licensure is more than the third party's requirements as the third length of licensure crosses the threshold. In implementations, less than one minute may elapse between the reception of the request for length of licensure and the profile generator 620 completing stages 2806-2858 and communicating the third length of licensure back to the third party 124. In other implementations the completion of stages 2806-2858 and communication of the third length of licensure can take 10 seconds or less after receiving the request. The completion of stages 2806-2858 and communication of the length of licensure back to the third party 124 can occur while the person 150 continues to interact (e.g., before the person 150 exits the application) with the application executed by the third party system 124.

In some situations, the system 132 may not locate a cached record or another record in another state. Also, the system 132 may not locate any indication of a previous license in the records that are located. In these situations, the system 132 may not be able to verify that the person 150 has a length of licensure that crosses the threshold. Thus, the system 132 may, in these situations. provide indication that existing records do not show length of licensure is adequate, in stage 2860. Thus, the system 132 may provide the longest length of licensure, which may be similar to data structure 2400 shown in FIG. 24, but which also shows the best-determined length of licensure does not cross the threshold.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more implementations, configurations, or aspects for the purpose of streamlining the disclosure. The features of the implementations, configurations, or aspects of the disclosure may be combined in alternate implementations, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed implementation, configuration, or aspect. Thus, the following claims are hereby incorporated into this Detailed Description, with each claim standing on its own as a separate preferred implementation of the disclosure.

Moreover, though the description of the disclosure has included description of one or more implementations, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative implementations, configurations, or aspects to the extent permitted, including alternate, interchangeable and/or equivalent structures, functions, ranges, or operations to those claimed, whether or not such alternate, interchangeable and/or equivalent structures, functions, ranges, or operations are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an implementation that is entirely hardware, an implementation that is entirely software (including firmware, resident software, micro-code, etc.) or an implementation combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary, brief description of the drawings, detailed description, abstract, and claims themselves.

Aspects of the present disclosure include a method comprising: receiving driver information at a system that evaluates risk; evaluating driver risk and issuing a denial code; establishing if the driver is denied based on the denial code; receiving user interface input to provide information about the driver; and in response to the user interface input, providing the denial code to the user interface.

Any of the one or more aspects described herein, further comprising: determining a type of denial code; and based on the type of denial code, automatically ordering a motor vehicle record from a motor vehicle system.

Aspects of the present disclosure include a method comprising: receiving driver information, for a driver, at a system that evaluates risk; determining if the driver information matches information in an motor vehicle record (MVR) datastore; determining if a license is associated with the information in the MVR datastore; establish a confidence interval that the license is actually describing the driver; receiving user interface input to provide information about the driver; and in response to the user interface input, providing the license and the confidence interval to the user interface.

Aspects of the present disclosure include a method comprising: receiving driver information, for a driver, at a system that evaluates risk; determining if the driver information matches information in an motor vehicle record (MVR) database; determining if an identity of the driver exists in the information in the MVR datastore; establish a confidence interval that the identity is actually describing the driver; receiving user interface input to provide information about the driver; and in response to the user interface input, providing the identity and the confidence interval to the user interface.

Aspects of the present disclosure include a method comprising: obtaining model data associated with assessing risk of a driver; generating a model to assess risk of a driver; determine a best factor that indicated the risk of a driver; and provide the model with the best factor.

Any of the one or more aspects described herein, wherein obtaining model data further comprises: retrieving data from multiple sources; holding back a first portion of the data to verify the model after the model is generated; determining if proxy data is needed; if proxy data is needed, generating the proxy data; grouping the data into like cohorts; and providing the data to a model engine.

Any of the one or more aspects described herein, wherein generating the model further comprises: establishing an observation period; creating an initial model with data from the observation period; establishing a performance period; and verifying the model during the performance period.

Any of the one or more aspects described herein, further comprising: retrieving the model; providing information about a driver to the model; determining a risk profile from the model; determining a risk score from the model; determining the factors affecting the risk score; receiving user interface input to provide information about the driver; and in response to the user interface input, providing the risk score to the user interface.

Any of the one or more aspects described herein, further comprising: comparing the risk score to a policy associated with driver risk; determine if there is a discrepancy between the risk score and an effect of the policy; determine a correction is needed to the policy; and provide suggestions to change the policy.

Aspects of the present disclosure include a method comprising: retrieving a driver profile; determining if a motor vehicle record (MVR) associated with the driver profile is needed; searching a local source for the MVR; determining if the MVR is located in the local source; if the MVR is located in the local source, retrieving the MVR from the local source; determining if the MVR requires updating; and if the MVR requires updating, retrieving a new MVR from a distant source.

Aspects of the present disclosure include a method comprising: determining a risk score associated with a risk of a driver; determining a trend in the risk score; comparing the risk score and/or the trend to a threshold; if the risk score and/or the trend crosses the threshold, providing driver remediation; and based on the remediation, adjusting the risk score.

Aspects of the present disclosure include a user interface method comprising: receiving a first selection in a first user interface to provide driver profiles and/or risk scores; based on the first selection, providing a second user interface that provides risk scores for two or more drivers; receiving a selection of a driver associated with a risk score; providing a third user interface that presents a driver profile associated with the selected driver; and presenting a factor in the third user interface, with the driver profile, that indicates how the risk score presented in the second user interface was derived.

Any of the one or more aspects herein, wherein the components are one or more of an Application Specific Integrated Circuit (ASIC), a processor, memory, Field Programmable Gate Array (FPGA), System-on-Chip (SOC), or a physically separate device.

A means of or for any of the one or more aspects herein.

A system, component, hardware, software, data, user interfaces, signals or signaling processes and systems, etc. for conducting any of the one or more aspects herein.

Any of the one or more aspects herein in combination with any of the other one or more above aspects.

What is claimed is:

1. A method comprising:
receiving a request, from a third party, to determine length of licensure;
accessing two or more data stores having data regarding a person associated with licensure;
interrogating a record associated with the person accessed from one of the two or more data stores;
if an indication of licensure is located the record, determining a length of licensure; and
providing the length of licensure to the third party.

2. The method of claim 1, wherein the one of the two or more data store is one of a Motor Vehicle Record data store, a financial entity database, or court database.

3. The method of claim 1, wherein retrieving, accessing, interrogating, determining, and providing occurs in less than one minute.

4. The method of claim 1, wherein retrieving, accessing, interrogating, determining, and providing occurs in less than 10 seconds.

5. The method of claim 1, wherein the indication of licensure is one of: a date of issuance of a license, a ticketed traffic violation, or an adjudication of a traffic violation.

6. The method of claim 1, further comprising:
accessing a Commercial Driver's License (CDL) database for information about a CDL associated with the person;
providing the information, from the CDL database, about three states in which the person was issued the CDL.

7. The method of claim 1, wherein providing the length of licensure comprises providing a date of an event that indicates an earliest licensure and a data source from which the event was located.

8. The method of claim 1, further comprising:
determining a first length of licensure, from the record, crosses a threshold;
if the first length of licensure crosses the threshold, providing the first length of licensure;
if the first length of licensure does not cross the threshold, accessing a record cache to determine if a second record includes data regarding the person, if the second record includes the data regarding the person:
interrogating the second record associated with the person;
determining a second length of licensure; and
if the second length of licensure crosses the threshold, providing the second length of licensure.

9. The method of claim 8, further comprising:
if the second length of licensure does not cross the threshold, accessing a financial database to locate a license used to apply for credit;
determining a state from which the license was issued; and
accessing a database associated with the state to search for the length of licensure.

10. The method of claim 1, wherein the request is received from a third party.

11. The method of claim 1, wherein the person interacts with the third party through an application, and wherein retrieving, accessing, interrogating, determining, and providing occurs before the person exits the application.

12. A computer readable medium having instructions stored thereon, wherein, when the instructions are executed by a processor, the processor conducts a method, the method comprising:
receiving a request to determine a length of licensure;
accessing two or more data stores having data regarding a person associated with licensure;
interrogating a record associated with the person accessed from one of the two or more data stores;
if an indication of licensure is located the record, determining the length of licensure; and
providing the length of licensure, wherein less than 10 seconds elapses from a first time when the request is received to a second time when the length of licensure is provided.

13. A system comprising:
a third party interface;
a Motor Vehicle Record (MVR);
a record cache;
a memory storing instructions thereon; and
a processor in communication with the record cache and the memory, the processor operable to execute the instructions, which cause the processor to execute a method, the method comprising:
receiving, from a third party and through the third party interface, a request for a length of licensure of a person;
interrogating the MVR, based on the MVR;
determining a first length of licensure;
if the first length of licensure crosses a threshold, providing the first length of licensure;
if the first length of licensure does not cross the threshold, accessing the record cache to determine if a second record includes data regarding the person, if the second record includes data regarding the person:
interrogating the second record associated with the person;
determining a second length of licensure; and
if the second length of licensure crosses the threshold, providing the second length of licensure.

14. The system of claim 13, further comprising: a financial database interface.

15. The system of claim 14, wherein, the processor is in communication with the financial database interface, and wherein if the second length of licensure does not cross the threshold:
accessing a financial database, through the financial database interface, to locate a license used to apply for credit; and
determining a state from which the license was issued.

16. The system of claim 13, further comprising: a state database interface.

17. The system of claim 13, wherein, the processor is in communication with the state database interface, and wherein if the second length of licensure does not cross the threshold:
accessing a state database, through the state database interface, to locate a second record associated with the person; and
interrogating the second record, based on the second record:
determining a third length of licensure; and
if the third length of licensure crosses the threshold, providing the third length of licensure.

18. The system of claim 17, wherein the state database is one of a state MVR datastore or a state court database.

19. The system of claim 17, wherein the first length of licensure, the second length of licensure, or the third length of licensure comprises a date of an event that indicates an earliest date of licensure and a data source from which the event was located.

20. The system of claim 17, wherein less than a minute elapses between receiving the request and providing one of the first length of licensure, the second length of licensure, or third length of licensure.
